(19) United States
(12) Patent Application Publication
(10) Pub. No.: US 2024/0363907 A1
(43) Pub. Date: Oct. 31, 2024

(54) Nanocellulose-Carboxymethylcellulose Electrolyte for Stable, High-Rate Zinc-Ion Batteries

(71) Applicant: University of Maryland, College Park, College Park, MD (US)

(72) Inventors: Liangbing Hu, Rockville, MD (US); Lin XU, McLean, VA (US)

(73) Assignee: University of Maryland, College Park, College Park, MD (US)

(21) Appl. No.: 18/599,163

(22) Filed: Mar. 7, 2024

Related U.S. Application Data
(60) Provisional application No. 63/488,943, filed on Mar. 7, 2023.

(51) Int. Cl. H01M 10/38

(52) U.S. Cl. CPC H01M 10/38; H01M 2300/0002; H01M 2300/0082

(57) ABSTRACT

The present disclosure is directed to electrolyte membrane compositions, electrolyte membranes, batteries utilizing said electrolyte membranes, and methods of assembling said batteries. The electrolyte membranes disclosed herein provide membranes and electrolytes for sustainable and more robust batteries.

### CROSS REFERENCE TO RELATED APPLICATION(S)

This application claims priority to U.S. Application No. 63/488,943, filed on Mar. 7, 2023, the contents of which are hereby incorporated by reference in its entirety.

### STATEMENT OF FEDERALLY SPONSORED RESEARCH AND DEVELOPMENT

This invention was made with government support under DEAR0001588 awarded by the U.S. Department of Energy ARPA-E. The government has certain rights in the invention.

### FIELD OF THE INVENTION

The field of the invention relates generally to electrochemical cells, and more particularly, to electrochemical cell components comprising cellulose, and even more particularly, to electrolyte membranes for use in batteries comprising cellulose-CMC compositions.

### BACKGROUND

This background information is provided for the purpose of making information believed by the applicant to be of possible relevance to the present invention. No admission is necessarily intended, nor should it be construed, that any of the information disclosed herein constitutes prior art against the present invention.

Battery technology will play a pivotal role in the effort toward decarbonization and the fight against global warming by more fully enabling the use of renewable energy sources. Aqueous Zn ion batteries (ZIBs) are one of the most promising battery chemistries for applications such as grid-scale energy storage as they are safer than flammable organic-based systems, low-cost, environmentally friendly, and feature rapid charge/discharge rates. However, despite these advantages, ZIBs have not been widely commercialized, largely due to undesirable interactions between the electrolyte and Zn-metal anode, including dendritic growth on the anode surface, side reactions forming an inert passivation layer, as well as hydrogen evolution during the plating/stripping process. These effects can cause poor cycling reversibility of the Zn-metal anode, leading to battery failure on the anode side.

Many strategies of electrolyte modification have been explored to promote reversible Zn plating. While water is a clear component of aqueous Zn ion batteries that provides ionic conduction, reducing the free water content in the electrolyte helps eliminate detrimental side reactions. Methods based on this approach include “water-in-salt” electrolytes that feature ultra-high salt concentrations or the use of additives that act as water blockers. However, such liquid electrolytes do not provide additional mechanical strength to prevent dendritic growth and are therefore unable to sustain high current densities. To address this issue, hydrogel electrolytes have been developed, which feature a denser structure that helps inhibit the growth of Zn dendrites. Cellulose, which is one of the most abundant biomaterials on earth and is inherently a low-cost, green material, has been studied extensively as a building block of such hydrogel electrolytes for aqueous Zn ion batteries. In addition to providing mechanical strength that helps prevent dendrite growth, the cellulose structure helps to bond water and therefore limit the free water content to decrease interfacial side reactions. However, the molecular structure of cellulose limits how much water it can bond. As a result, cellulose-based electrolytes often feature either too much free water, which causes parasitic side reactions, or too little water after drying intended to remove free water, which leads to low Zn conductivities (FIG. 1A). Additionally, many cellulose-based hydrogel electrolytes incorporate multiple, synthetic cross-linking additives (e.g., polyacrylamide) to increase the mechanical strength of the membrane. But this approach limits the biodegradability of the material and increases the cost of processing. As a result, it has remained challenging to develop an electrolyte for aqueous ZIBs that enables high stability, cyclability, and the capability to withstand high current densities for high power density energy storage.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein. The patent or application file contains at least one drawing executed in color. Copies of this patent or patent application publication with color drawing(s) will be provided by the Office upon request and payment of the necessary fee.

FIGS. 1A-1B. FIG. 1 displays a cellulose-CMC electrolyte for aqueous Zn ion batteries. (A) When the electrolyte membrane is made of pure cellulose, there is either too much free water that causes parasitic side reactions, or too little water after drying that causes low Zn²⁺ conductivity. (B) In contrast, by adding CMC within the cellulose matrix, after a squeeze-dry process to reduce the amount of free water molecules and to mitigate parasitic side reactions, there are still water molecules bonded along the CMC chains, which enables the transport of the Zn ions.

FIGS. 2A-2E. FIG. 2 displays the characterization of the cellulose-5 wt % CMC electrolyte. FIG. 2A displays a digital image of the cellulose-CMC electrolyte. FIG. 2B displays an SEM image of the surface morphology of the cellulose-5% CMC electrolyte. FIG. 2C displays XRD patterns of the cellulose-5% CMC membrane before and after NaOH treatment. FIG. 2D displays the results of tensile tests of different NaOH-treated cellulose-CMC membranes (0-8 wt %), as well as a glass fiber separator as a control. All membranes are in wet state. FIG. 2E displays a graph of the ionic conductivity of a wet glass fiber separator, as well as various cellulose-CMC membranes (0-5 wt % CMC) after different drying conditions: wet, squeezed dry by Kimwipes with 0.5 MPa pressure, and vacuum dried for 30 s. The thicknesses of the electrolytes were 80 μm.

FIGS. 3A-3E. FIG. 3 displays the reduction of the dendritic growth of Zn by the cellulose-5% CMC membrane. FIGS. 3A and 3B display the morphology of Zn plating on the Zn anode after cycling at 10 mA/cm² and 5 mAh/cm² for 50 cycles in Zn∥Zn cells fabricated with 2 M ZnSO₄ aqueous electrolyte with a glass fiber separator (Fog. 3A) and cellulose-5% CMC electrolyte (FIG. 3B). FIG. 3C displays XRD patterns of the Zn foils after cycling with the 2 M ZnSO₄ aqueous electrolyte (with glass fiber separator) and the cellulose-5% CMC electrolyte, as well as a pristine Zn foil without cycling. FIGS. 3D and 3E display schematic diagrams of Zn plating on the Zn anode using the aqueous electrolyte (FIG. 3D) and cellulose-5% CMC electrolyte (FIG. 3E).

FIGS. 4A-4D. FIG. 4 displays the electrochemical performance of Zn plating/stripping. FIG. 4A displays the Zn plating/stripping of a Zn∥Zn symmetric cell at 10 mA/cm² and 5 mAh/cm² using the cellulose-5% CMC electrolyte and aqueous electrolyte with glass fiber separator (grey line). FIG. 4B displays the Zn plating/stripping of a Zn∥Zn symmetric cell at 80 mA/cm² and 4 mAh/cm² using the cellulose-5% CMC electrolyte. FIG. 4C displays a performance comparison of the Zn∥Zn symmetric cell in terms of the current density and cumulative capacity cycled using the cellulose-5% CMC electrolyte and other reported electrolytes. FIG. 4D displays the Zn plating/stripping of a Zn∥Cu asymmetric cell at 10 mA/cm² and 2 mAh/cm².

FIGS. 5A-5D. FIG. 5 displays the electrochemical performance of Zn∥MnO₂ full cells using the cellulose-5% CMC electrolyte. FIG. 5A displays galvanostatic charge-discharge potential profiles of the Zn∥MnO₂ cell using cellulose-5% CMC electrolyte at 8C. FIG. 5B displays the capacity and coulombic efficiency of the Zn∥MnO₂ cell using cellulose-5% CMC electrolyte at 8C. FIG. 5C displays the galvanostatic charge-discharge potential profiles of the Zn∥MnO₂ cell using cellulose-5% CMC electrolyte at various rates. FIG. 5D displays the rate performance of the Zn∥MnO₂ cell using cellulose-5% CMC electrolyte ranging from 1C to 16C.

FIG. 6. FIG. 6 displays a schematic diagram of the preparation of the cellulose-CMC membrane.

FIG. 7. FIG. 7 displays the AFM characterization of the cellulose nanofibers, which feature diameters of tens of nanometers and lengths of several microns.

FIGS. 8A-8B. FIGS. 8A and 8B display surface contact angles of water on the cellulose-5 wt % CMC electrolyte and a commercial Celgard membrane, respectively. The cellulose-CMC electrolyte shows excellent hydrophilicity.

FIG. 9. FIG. 9 displays a cross-sectional SEM image of the cellulose-5% CMC membrane before the NaOH treatment, exhibiting a dense structure.

FIG. 10. FIG. 10 displays a cross-sectional SEM image of the cellulose-5% CMC membrane after the NaOH treatment, exhibiting a dense structure.

FIG. 11. FIG. 11 displays the electrochemical window of the cellulose-5 wt % CMC membrane before and after the NaOH treatment. No significant difference was observed.

FIG. 12. FIG. 12 displays tensile tests of the cellulose-5% CMC membrane before and after NaOH treatment, as well as a glass fiber separator as a control.

FIG. 13. FIG. 13 displays XRD patterns of the cellulose membrane before and after NaOH treatment.

FIG. 14. FIG. 14 displays FTIR spectra of the cellulose-5% CMC membrane before and after the NaOH treatment. No significant difference was observed.

FIGS. 15A-15C. FIG. 15 displays EIS spectra of varying amounts of CMC in the membranes and different drying methods. EIS of the cellulose-only (red), cellulose-2% CMC (green) and cellulose-5% CMC (blue) membranes were compared by wet measurement (FIG. 15A), squeeze-drying with Kimwipes using 0.5 MPa pressure (FIG. 15B), and placing under vacuum for 30 s after squeeze-dry (FIG. 15C). The thicknesses of electrolytes were 80 μm.

FIG. 16. FIG. 16 displays the residual mass (Mass(t)/Mass(t0)) of the different cellulose-CMC membranes (0-5 wt % CMC) as a function of time. The ambient temperature was 25° C. and the relative humidity was fixed at 1%.

FIGS. 17A-17D. FIGS. 17A and 17C displays EIS spectra of a glass fiber separator and the cellulose-5% CMC electrolyte, respectively. FIGS. 17B and 17D displays the corresponding DC polarization curves with 10 mV bias of the glass fiber separator and cellulose-5% CMC electrolyte, respectively.

FIGS. 18A-18B. FIG. 18A and FIG. 18B display digital images of the Zn∥Zn symmetric cell after 160 cycles with the aqueous electrolyte and glass fiber separator and after 350 cycles with the cellulose-5% CMC electrolyte, respectively. It is hypothesized that the observed swelling of the coin cell using the aqueous electrolyte/glass separator was due to the hydrogen evolution reaction, while the cellulose-CMC does not show this effect.

FIG. 19. FIG. 19 displays the Zn plating/stripping of a Zn∥Zn symmetric cell at 40 mA/cm² and 8 mAh/cm² using the cellulose-5% CMC electrolyte.

FIG. 20. FIG. 20 displays tensile tests of the cellulose-5% CMC electrolyte before and after 3400 Zn∥Zn cycles at 80 mA/cm².

FIG. 21. FIG. 21 displays the coulombic efficiency of the Zn∥Cu asymmetric cell using the cellulose-5% CMC electrolyte at 10 mA/cm² and 2 mAh/cm². The fluctuation during >400 cycles is likely due to the inevitable dendrite formation on Cu, although it is already suppressed comparing to aqueous electrolyte.

FIG. 22. FIG. 22 displays cycling performances of Zn∥MnO₂ cells made using the cellulose-5% CMC electrolyte, cellulose-only electrolyte (0% CMC), and aqueous electrolyte with a glass fiber separator at 8C′.

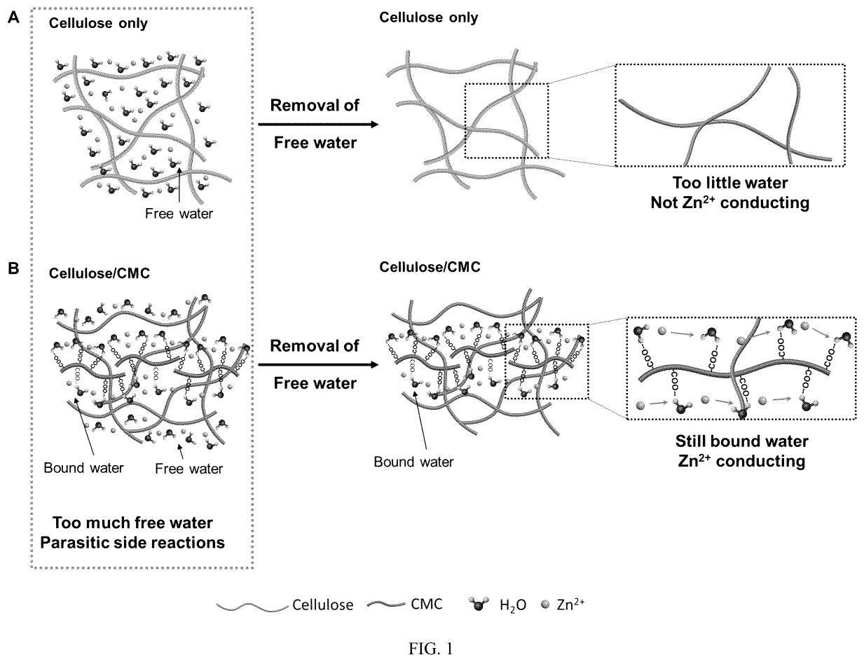

Particular non-limiting embodiments of the present invention will now be described with reference to accompanying drawings.

### DESCRIPTION

All publications mentioned herein are incorporated by reference to the extent they support the present invention.

### 1.0 DEFINITIONS

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

As used herein, the term “AFM” refers to atomic force microscopy.

As used herein, the term “bound water” refers to water molecules that are retained by the electrolyte membrane composition disclosed herein. The amount of bound water in the compositions disclosed herein can be measured using the method described in Example 7 herein. The amount of bound water in the compositions disclosed herein can also be measured using thermogravimetric scans.

As used herein, the term “nanofiber gel” refers to nanocellulose fibers in suspension in polar solvent such as water.

As used herein, the term “quasi-solid” refers to a mixture of solid and liquid, wherein more than 50% of the mixture is in the solid phase.

As used herein, the term “quasi-liquid” refers to a mixture of solid and liquid, wherein more than 50% of the mixture is in the liquid phase.

The term “multiple layered material” as used herein refers to a material obtained by layering a cathode, a electrolyte membrane disclosed herein, and an anode.

The term “electrolyte membrane-cathode material” as used herein refers to a material obtain by a method comprising depositing an electrolyte membrane disclosed herein onto a cathode.

It is to be understood that both the foregoing descriptions are exemplary, and thus do not restrict the scope of the invention.

### 2.0 NON-LIMITING EMBODIMENTS

One aspect of the present disclosure pertains to a nanocellulose-carboxymethylcellulose (cellulose-CMC) electrolyte that features high ionic conductivity, mechanical strength, and low free water content that enables both high-rate and long-cycle-life aqueous ZIBs. CMC polymer chains are distributed within the relatively ridged cellulose network to form a dense, quasi-solid-state electrolyte that also functions as the battery separator. CMC, an inexpensive and commercially available cellulose derivative, features numerous carboxyl groups that form stronger bonding interactions with water molecules compared to cellulose alone, which can help limit the free water content when used in a membrane. The increased bound water content helps promote Zn ion conductivity, while simultaneously preventing excess free water molecules from engaging in parasitic side reactions. A facile NaOH treatment also increases the tensile strength of the cellulose-CMC electrolyte to >70 MPa. As a result, the cellulose-CMC electrolyte shows a high Zn ionic conductivity of up to 26 mS/cm and stable Zn electroplating/stripping as parallel platelets on the Zn anode at ultra-high current densities as high as 80 mA/cm². The side reactions caused by free water molecules, such as hydrogen evolution and the formation of a passivating Zn₄SO₄(OH)₆·xH₂O layer, are also greatly reduced. Another aspect of present disclosure pertains to a Zn∥MnO₂ full battery based on this cellulose-CMC electrolyte, which shows excellent cyclability of over 500 cycles at a rate of 8C. Additionally, the electrolyte requires minimal processing and is composed of inherently biodegradable materials without any synthetic additives from fossil fuels, suggesting its potential as a low-cost, sustainable, and high-performance electrolyte for next-generation energy storage applications.

Another aspect of the present disclosure pertains to an electrolyte membrane composition, said composition comprising cellulose, carboxymethylcellulose, one or more salts, and water, wherein said water in said composition is bound water. In some embodiments, the cellulose comprises fibers. Said cellulose fibers may have a variety of sizes. In some embodiments, the fibers have a size in the range of about 1 nm to about 100 μm, or in the range of about 1 nm to 50 μm, or in the range of about 1 nm to about 1 μm, or in the range of about 1 nm to about 500 nm, or in the range of about 1 nm to about 100 nm. In other embodiments, the fibers have a size in the range of about 10 nm to about 50 nm.

In some embodiments, the cellulose is a nanofiber gel. The nanofiber gel may comprise cellulose nanofibers suspended in water. Furthermore, the electrolyte membrane composition may be a quasi-solid. In some embodiments, the composition comprises a mixture of solid and liquid wherein the composition is >50% solid by weight. The electrolyte membrane composition may also be a quasi-liquid. In some embodiments, the composition comprises a mixture of solid and liquid wherein the composition is >50% liquid by weight.

In some embodiments, the electrolyte membrane composition comprises cellulose in the range of about 75% to about 99.9% by weight, or in the range of about 80% to about 99% by weight, or in the range of about 90 to about 98% by weight. In other embodiments, the composition comprises about 95% cellulose by weight.

In some embodiments, the electrolyte membrane composition comprises carboxymethylcellulose in the range of about 0.1% to about 25% by weight, or in the range of about 1% to about 20% by weight, or in the range of about 2% to about 10% by weight. In other embodiments, the composition comprises about 5% carboxymethylcellulose by weight.

In some embodiments, the water in said composition is substantially bound, or the composition is substantially free of unbound water. In some embodiments, the composition is free of water. In other embodiments, the bound water content of the composition is in the range of about 0% to about 80% by weight, 0.01% to about 80% by weight, about 10% to about 70% by weight, about 15% to about 50% by weight, or about 20% to about 40% by weight. In further embodiments, the bound water content is about 35% by weight. In other embodiments, the bound water content is about 60% by weight. In yet further embodiments, the bound water content is in the range of about 0% to about 10% by weight, or about 0.01% to about 10% by weight, or about 0.01% to about 5% by weight.

The electrolyte membrane composition comprises one or more salts. In some embodiments, said one or more salts have the form of XY, wherein X is a positively charged cation, and wherein Y is a negatively charged anion. XY as present in the compositions disclosed herein has a neutral overall charge. In some embodiments, positively charged cation X is chosen from Zn²⁺, Li⁺, Na⁺, K⁺, NH₄⁺, Al³⁺, and Mg²⁺. In other embodiments, negatively charged anion Y is chosen from SO₄²⁻, Cl⁻, CF₃SO₃⁻, and NO₃⁻. In further embodiments, said salt is ZnSO₄.

Another aspect of the present disclosure pertains to an electrolyte membrane composition, said composition comprising cellulose, a polymer, one or more salts, and water, wherein said water in said composition is substantially bound. In some embodiments, said polymer is hydrophilic. In further embodiments, said polymer is chosen from carboxymethylcellulose, alginate, chitosan, chitin, xanthan gum, pectin, gellan gum, guar gum, hyaluronic acid, and starch, or combinations thereof.

In another aspect, the present disclosure pertains to an electrolyte membrane, said membrane comprising the electrolyte membrane composition of the previous embodiments. In some embodiments, said membrane contains a plurality of pores, or is porous. In other embodiments, said pores have a size in the range of about 1 nm to about 1 mm. In other embodiments, said pores have a size in the range of about 1 nm to about 100 nm, or about 1 nm to about 50 nm or about 50 nm to about 100 nm.

Another aspect of the present disclosure pertains to a method of making the electrolyte membrane of the previous embodiments, said method comprising the steps of:
suspending cellulose in water;
dissolving carboxymethylcellulose in water to form a solution;
combining the carboxymethylcellulose solution with the cellulose suspension;
thoroughly mixing the subsequent suspension; and
a separation step.

In some embodiments, the separation step is chosen from evaporation, vacuum filtration, and gravity filtration.

In further embodiments, the method further comprises the steps of soaking the membrane for a period of time in an NaOH solution; rinsing the material with water; and applying pressure to remove excess water. In some embodiments, the NaOH solution has a concentration in the range of about 5% to about 20% by weight. In other embodiments, the NaOH solution has a concentration of about 20% by weight. In further embodiments, soaking the membrane in the NaOH solution occurs over a period of time in the range of about 1 hour to about 24 hours, or in the range of about 5 hours to about 15 hours. In still other embodiments, the membrane is soaked in the NaOH solution for about 12 hours.

Another aspect of the present disclosure pertains to a battery, said battery comprising a cathode, an anode, and the electrolyte membrane of the previous embodiments. In some embodiments, the battery is a symmetric cell, an asymmetric cell, or a full cell. In other embodiments, the cathode comprises Zn, Cu, V₂O₅, LiFePO₄, NH₄V₄O₁₀, MnO₂, or combinations thereof. In further embodiments, the anode comprises Zn, Al, Mg, Li, K, Na, Si, graphite, or combinations thereof. In some embodiments, the cathode comprises MnO₂. In further embodiments, said MnO₂ comprises nanorods. In other embodiments, the cathode comprises Zn. In some embodiments, the anode comprises Zn.

One aspect of the present disclosure pertains to a method of assembling a battery, said method comprising layering a cathode, an electrolyte membrane disclosed herein, and an anode to obtain multiple layered material. In some embodiments, method of assembling a battery, said method comprising depositing an electrolyte membrane disclosed herein onto a cathode to obtain electrolyte membrane-cathode material and depositing an anode onto said electrolyte membrane-cathode material. The anode may be optionally sealed (e.g. mechanically sealed) in a battery casing.

### LIST OF EMBODIMENTS

The following is a list of non-limiting embodiments:
1. An electrolyte membrane composition, said composition comprising cellulose, carboxymethylcellulose, one or more salts, and water, wherein said water is bound water.
2. The composition of embodiment 1, wherein said cellulose comprises fibers.
3. The composition of embodiment 2, wherein said fibers have a size in the range of about 1 nm to about 100 μm.
4. The composition of embodiment 2, wherein said fibers have a size in the range of about 10 nm to about 50 nm.
5. The composition of embodiment 1, wherein said cellulose is a nanofiber gel.
6. The composition of embodiment 1, wherein the composition is in the form of a quasi-solid state.
7. The composition of embodiment 1, wherein the composition is in the form of a quasi-liquid state.
8. The composition of embodiment 1, wherein said composition comprises about 75% to about 99.9% cellulose by weight.
9. The composition of embodiment 1, wherein said composition comprises about 90% to about 98% cellulose by weight.
10. The composition of embodiment 1, wherein said composition comprises about 95% cellulose by weight.
11. The composition of embodiment 1, wherein said material comprises about 0.1% to about 25% carboxymethylcellulose by weight.
12. The composition of embodiment 1, wherein said material comprises about 2% to about 10% carboxymethylcellulose by weight.
13. The composition of embodiment 1, wherein said material comprises about 5% carboxymethylcellulose by weight.
14. The composition of embodiment 1, wherein the bound water is present in the range of about 0.01% to about 80% by weight, or 0.01% to about 20% by weight, or about 20% to about 80% by weight.
15. The composition of embodiment 14, wherein the bound water is present in about 60% by weight.
16. The composition of embodiment 14, wherein the bound water is present in the range of about 20% to about 40% by weight.
17. The composition of embodiment 14, wherein the bound water content is about 35% by weight.
18. The composition of embodiment 1, wherein said one or more salts have the form of XY, wherein X is a positively charged cation, Y is a negatively charged anion, and are combined in such a way as to render a neutral overall charge.
19. The composition of embodiment 18, wherein X is chosen from Zn²⁺, Li⁺, Na⁺, K⁺, NH₄⁺, Al³⁺, and Mg²⁺.
20. The composition of embodiment 18, wherein Y is chosen from SO₄²⁻, Cl⁻, CF₃SO₃⁻, and NO₃⁻.
21. The composition of embodiment 18, wherein said salt is ZnSO₄.
22. An electrolyte membrane composition, said composition comprising cellulose, a polymer, one or more salts, and water, wherein said water is bound water.
23. The composition of embodiment 22, wherein said polymer is hydrophilic.
24. The composition of embodiment 22, wherein said polymer is chosen from carboxymethylcellulose, alginate, chitosan, chitin, xanthan gum, pectin, gellan gum, guar gum, hyaluronic acid, and starch, or combinations thereof.
25. An electrolyte membrane, said membrane comprising the electrolyte membrane composition of embodiment 1.
26. The membrane of embodiment 25, wherein said membrane is porous (i.e., contains pores).
27. The membrane of embodiment 26, wherein said membrane has pores with a size in the range of about 1 nm to about 1 mm.
28. The membrane of embodiment 27, wherein said pores have a size in the range of about 0.01 nm to about 100 nm.
29. A method of making a electrolyte membrane of embodiment 25, said method comprising the steps of:
   suspending cellulose in water;
   dissolving carboxymethylcellulose in water to form a solution;
   combining the carboxymethylcellulose solution with the cellulose suspension; thoroughly mixing the subsequent suspension;
   and a separation step.
30. The method of embodiment 29, wherein the separation step may be chosen from evaporation, vacuum filtration, and gravity filtration.
31. The method of embodiment 29, further comprising the steps of soaking the membrane for a period of time in an NaOH solution; rinsing the material with water; and applying pressure to remove excess water.
32. The method of embodiment 31, wherein said period of time is in the range of about 1 hour to about 24 hours.
33. The method of embodiment 31, wherein said period of time is in the range of about 5 hours to about 15 hours.
34. The method of embodiment 31, wherein said period of time is about 12 hours.
35. The method of embodiment 31, wherein said NaOH solution has a concentration in the range of about 1% to about 40% by weight.
36. The method of embodiment 31, wherein said NaOH solution has a concentration in the range of about 5% to about 20% by weight.
37. The method of embodiment 31, wherein said NaOH solution has a concentration of 20% by weight.
38. A battery, said battery comprising a cathode, an anode, and the electrolyte membrane of embodiment 1. The anode may comprise Zn, Al, Mg, Li, K, Na, Si, graphite, etc. The battery may be a symmetric cell, an asymmetric cell, or a full cell. The cathode in said symmetric cell, an asymmetric cell, or a full cell batter may comprise Zn, Cu, V₂O₅, LiFePO₄, NH₄V₄O₁₀, or MnO₂.
39. The battery of embodiment 38, wherein said cathode comprises Zn, Cu, V₂05, LiFePO₄, NH₄V₄O₁₀, MnO₂, or combinations thereof.
40. The battery of embodiment 38, wherein the cathode comprises Zn.
41. The battery of embodiment 38, wherein the cathode comprises MnO₂.
42. The battery of embodiment 41, wherein said MnO₂ comprises nanorods.
43. The battery of embodiment 38, wherein said anode comprises Zn, Al, Mg, Li, K, Na, Si, graphite, or combinations thereof.
44. The battery of embodiment 38, wherein the anode comprises Zn.
45. A method of assembling a battery of embodiment 38, said method comprising layering a cathode, a electrolyte membrane of embodiment 1, and an anode to obtain multiple layered material. For example, said method comprises depositing an electrolyte membrane disclosed herein onto a cathode to obtain electrolyte membrane-cathode material and depositing an anode onto said electrolyte membrane-cathode material. The anode may be optionally sealed (e.g. mechanically sealed) in a battery casing.

### 3.0 EXAMPLES

The following examples are provided solely to illustrate the present invention and are not intended to limit the scope of the invention, described herein. Further aspects of the invention are described in the following: Xu et. al, Nanocellulose-Carboxymethylcellulose Electrolyte for Stable, High-Rate Zinc-Ion Batteries, Adv. Funct. Mater. 2023, 33, 2302098, which is hereby incorporated by reference.

### Example 1. Material Preparation and Characterization

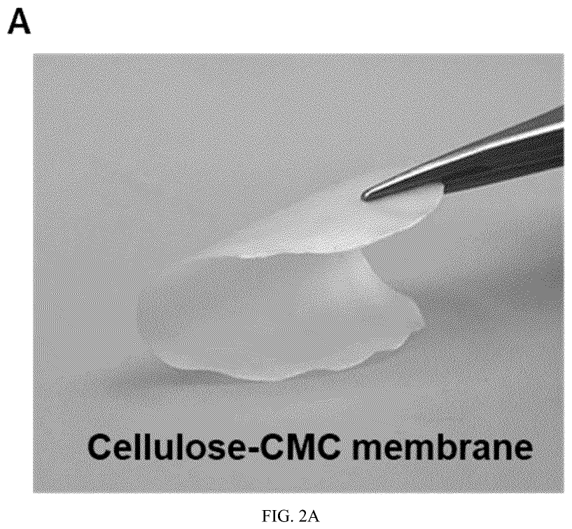

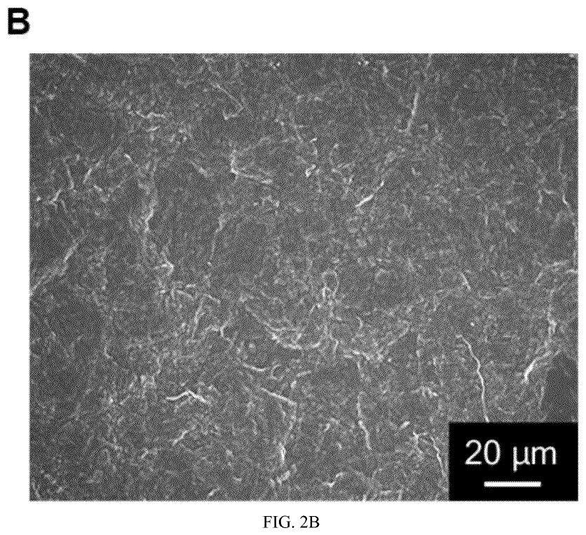

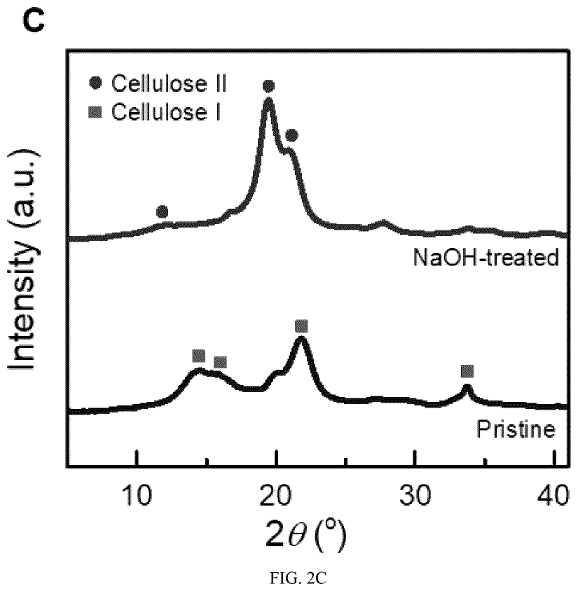

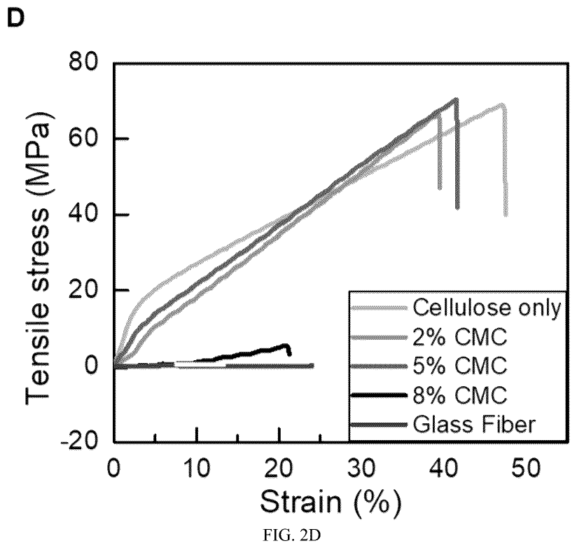

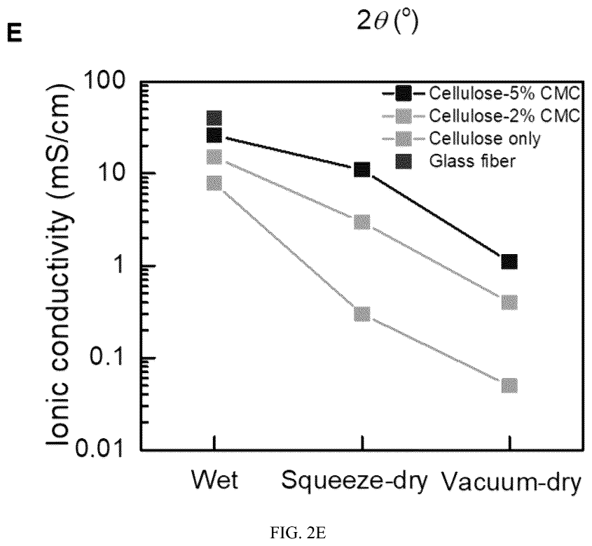

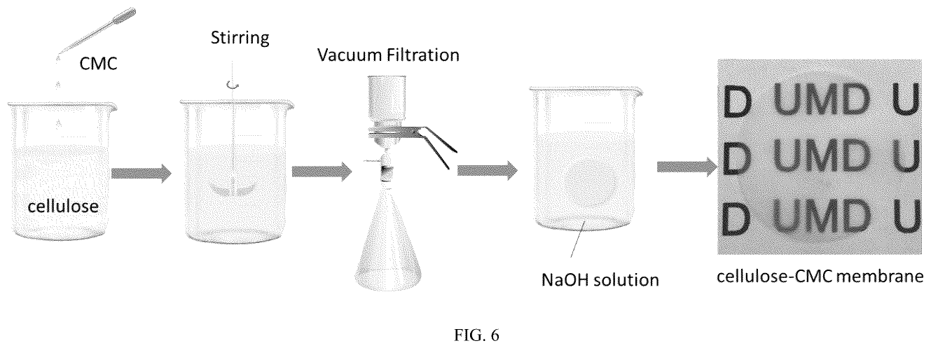

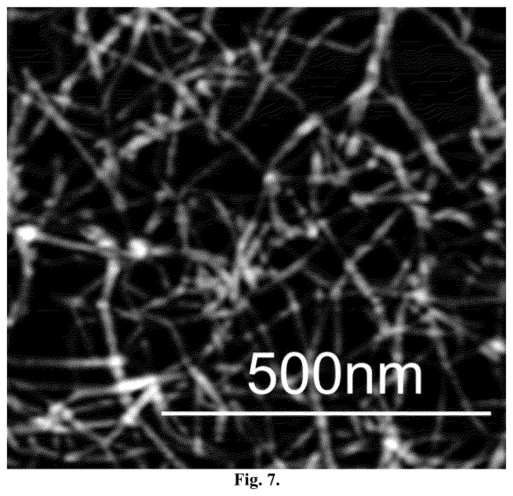

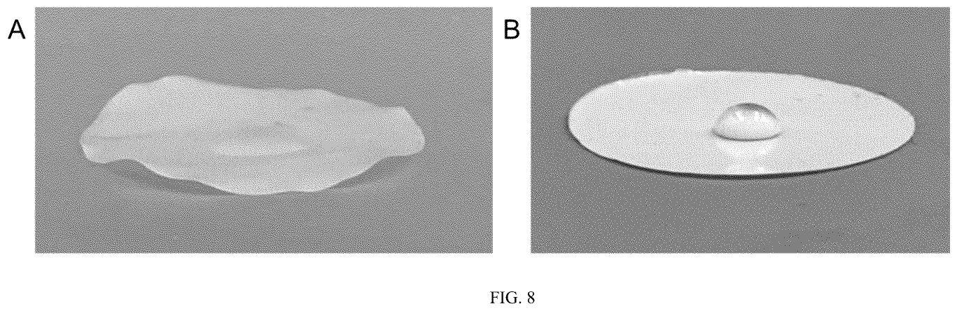

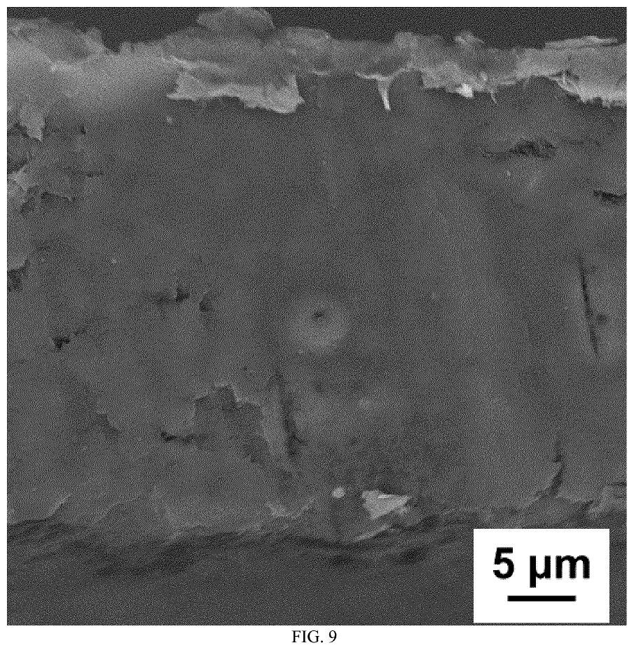

The cellulose-CMC electrolyte is prepared using a simple process including vacuum filtration and NaOH treatment (FIG. 6). To fabricate the membrane, a commercial cellulose nanofiber gel (FIG. 7) was first dispersed within DI water at a concentration of 0.1 wt %, then slowly pipetted different masses of 0.5 wt % CMC solution into the dispersion to produce samples with different CMC contents (2, 5, and 8 wt %). After thorough mixing, the resulting dispersions were vacuum-filtered through a Büchner funnel, collecting the pristine cellulose-CMC mixture on a filter membrane. Next, the membranes were immersed in NaOH solution (20 wt %) overnight to improve their tensile strength. The treated membranes were then rinsed with water until the pH of the washing solution reached 7. Finally, the membranes were immersed in a solution of 2 M ZnSO₄ to infiltrate the material with Zn²⁺ ions and were then squeezed between Kimwipes at a pressure of 0.5 MPa before cell assembly. The resulting cellulose-CMC electrolyte membranes were highly flexible (FIG. 2A) and featured good hydrophilicity (FIG. 8). As a control, a pure cellulose membrane was prepared using the same procedure but without the addition of CMC solution (0 wt % CMC).

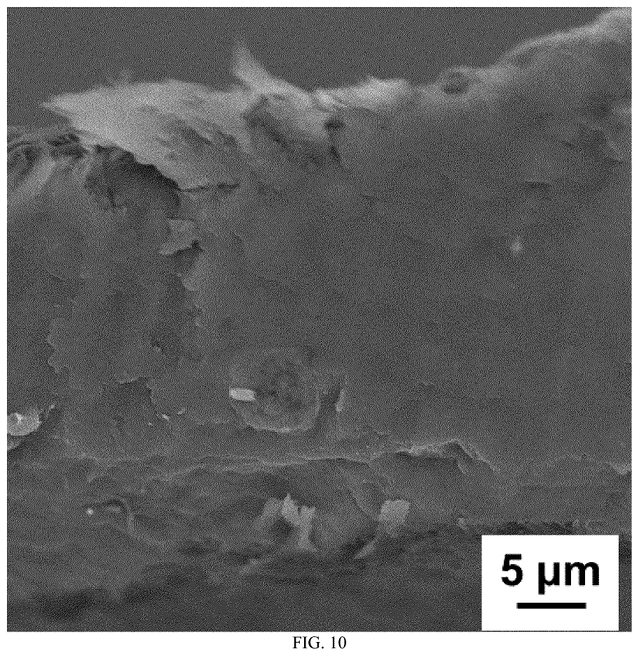

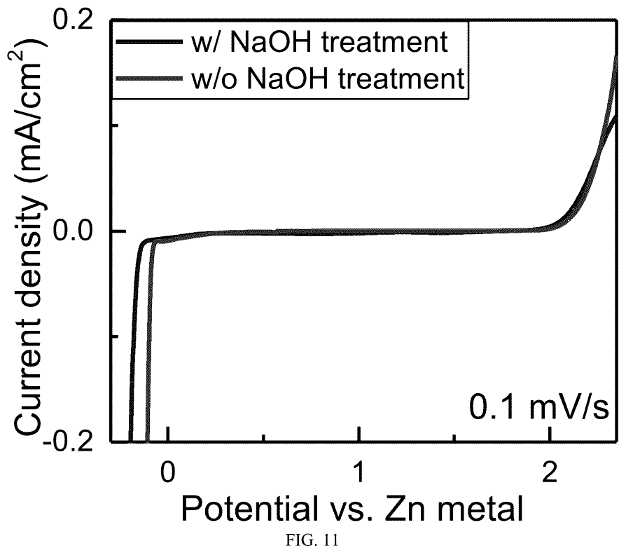

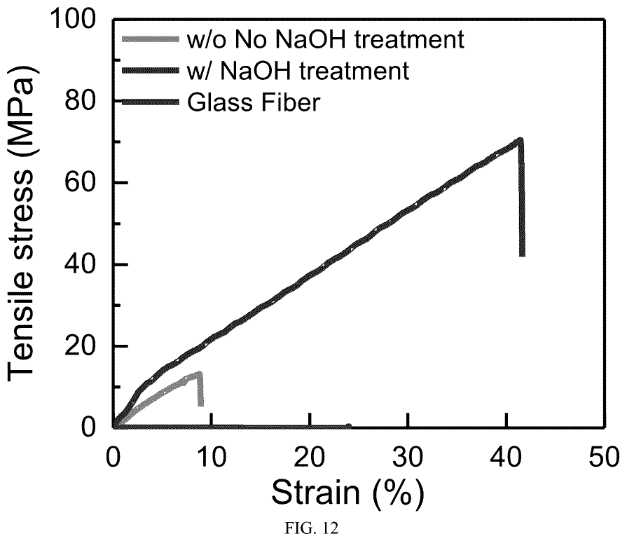

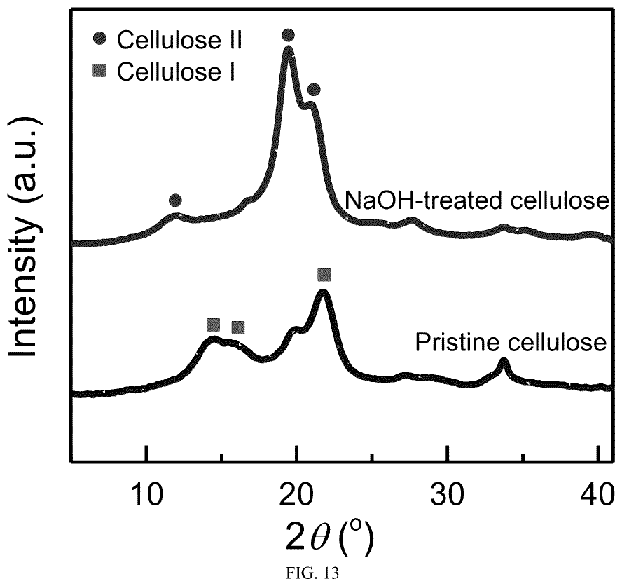

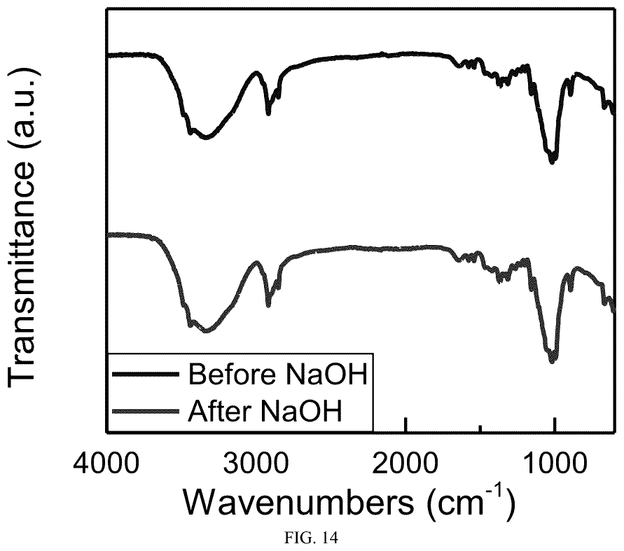

Scanning electron microscopy (SEM) was utilized and showed the cellulose-CMC membranes featured a dense structure. For example, prior to NaOH treatment, the cellulose-5% CMC membrane featured no visible pores at the micrometer scale (FIG. 9) and remained intact after the NaOH treatment (FIG. 2B, FIG. 10). The electrochemical window of the cellulose-5% CMC electrolyte did not show much change after the treatment (FIG. 11), indicating all remaining NaOH had been thoroughly rinsed away. However, the NaOH treatment did greatly improve the wet-state mechanical strength of the cellulose-based membrane, which aids in resisting perforation by Zn dendrites. As shown in FIG. 12, the NaOH-treated cellulose-5% CMC membranes displayed tensile strengths of 72±5 MPa in their wet state, which is much higher than that of the cellulose-5% CMC membrane before NaOH treatment (16±4 MPa) and the commonly used glass fiber separator (0.12±0.02 MPa), reaching higher or similar values as other hydrogel electrolytes. The increase in strength is a result of the transformation of cellulose's molecular structure under NaOH treatment, as confirmed by X-ray diffraction (XRD). Prior to treatment, the pristine cellulose (FIG. 13) and cellulose-5% CMC membrane (FIG. 2C) exhibits the XRD pattern of the cellulose I structure, which changes to match that of cellulose II after the NaOH treatment. Previous studies have shown that membranes with cellulose II structure have higher tensile strength compared to those with cellulose I as more intermolecular hydrogen bonds can be formed. Therefore, the NaOH treatment helps improve the mechanical strength of the cellulose membrane, allowing it to serve as a strong background matrix for the CMC molecules without changing the functional groups of the biopolymers, as indicated by Fourier transform infrared (FTIR) spectroscopy (FIG. 14).

To determine an optimal amount of CMC added to the cellulose, the tensile strength of the cellulose membranes featuring 0-8 wt % CMC were compared in their wet state (FIG. 2D). The tensile strengths of the membranes fabricated with 0 wt %, 2 wt %, and 5 wt % CMC were 72±5, 67±3, and 70±5 MPa, respectively, while the tensile strength is likely due to the increasingly-sparse distribution of the cellulose molecular chains.

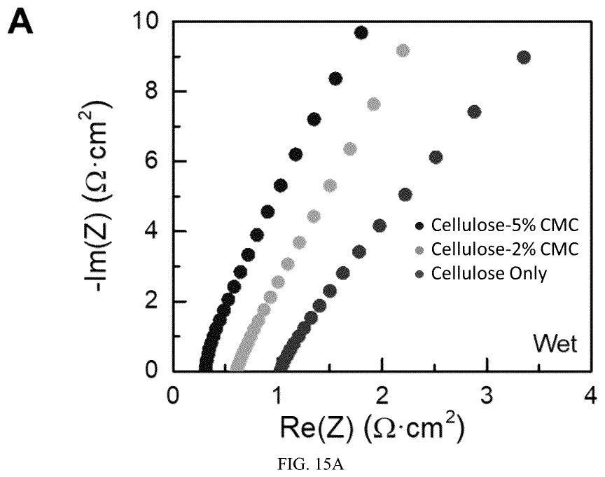

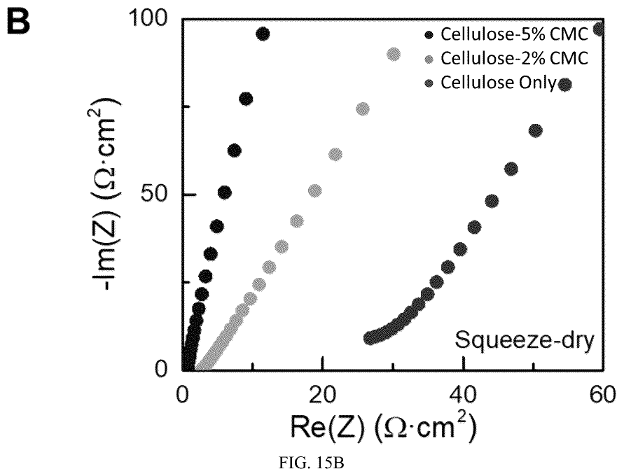

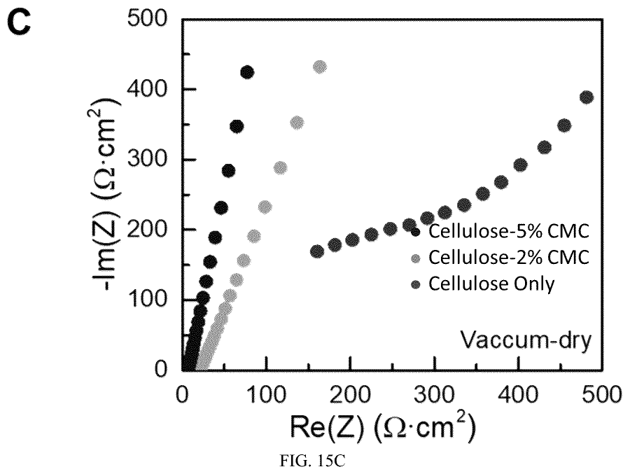

The Zn²⁺ conductivities of the 0-5 wt % cellulose-CMC samples were then compared under different wet states using electrochemical impedance spectroscopy (EIS, FIGS. 15A-C) and the calculated ionic conductivities were plotted (FIG. 2E). When all three membranes were in a wet state, the ionic conductivity was 7.8 mS/cm, 15 mS/cm, and 26 mS/cm for the 0, 2, and 5 wt % CMC samples, respectively. This trend indicates the enhancement of the conductivity by the addition of CMC. Moreover, after the three membranes were squeezed between Kimwipe tissues with an applied pressure of 0.5 MPa to remove some free water (squeeze-dry), the 5 wt % CMC membrane retained a relatively high ionic conductivity of 11 mS/cm, while the 0 and 2 wt % CMC membranes dropped to 0.3 mS/cm and 3 mS/cm, respectively. Finally, in the extreme case, the squeeze-dried membranes were placed in a vacuum chamber for 30 seconds (vacuum-dry) to remove more water. After vacuum treatment, the cellulose-only membrane (0 wt % CMC) had a negligible conductivity of 0.05 mS/cm, the 2 wt % CMC sample featured a conductivity of 0.4 mS/cm, while the 5 wt % CMC membrane retained a conductivity of 1.1 mS/cm.

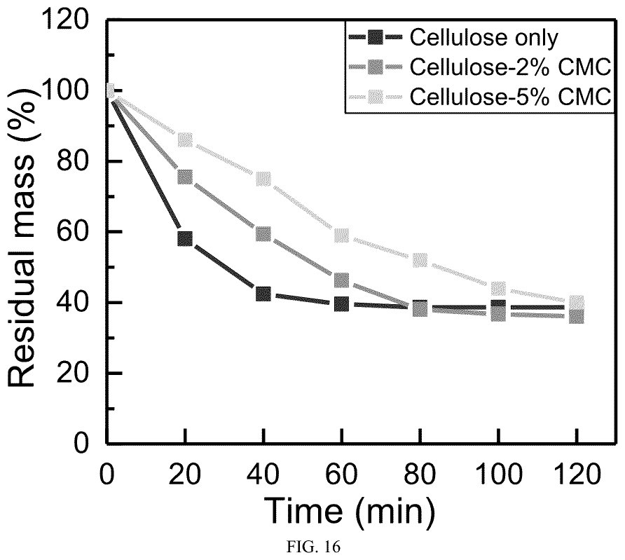

Differences in the observed ionic conductivities were attributed to the varying ability of the membranes to retain water depending on their CMC content. Table 1 summarizes the water content of the samples, which was measured by monitoring the change in mass after the different drying conditions. In all three cases, the cellulose-5 wt % CMC membrane retained more water than the other two samples, which is likely why it displayed better Zn²⁺ conductivity overall. The improved ability to retain water by adding CMC was also confirmed by both water retention (FIG. 16) and water uptake measurements (Table 2). When no CMC was present, the membrane lost 50 wt % of its water content within 10 min, while this time increased to ˜50 min for the 5 wt % CMC sample. As a result, 5 wt % was chosen as the optimal CMC percentage for further tests, attaining a balance between high mechanical strength and high ionic conductivity/ability to bond water molecules. However, further optimization may be possible for even better performance.

TABLE 1
Percentage of water in the cellulose-only (0 wt % CMC),
cellulose-2% CMC, and cellulose-5% CMC membranes
under the different drying conditions, including the
fully wet state, after squeeze-drying, and vacuum-drying.

| Percentage of CMC | Wet | Squeeze-dry | Vacuum-dry |
|---|---|---|---|
| 0% | 61 ± 3% | 30 ± 3% | 10 ± 1% |
| 2% | 63 ± 3% | 48 ± 4% | 25 ± 2% |
| 5% | 66 ± 5% | 60 ± 5% | 35 ± 2% |

TABLE 2
Water uptake of the different cellulose-CMC membranes
(0-5 wt % CMC).

| | Wt % of CMC | | |
|---|---|---|---|
| | 0% | 2% | 5% |
| Water uptake | 159 ± 5% | 178 ± 6% | 194 ± 5% |

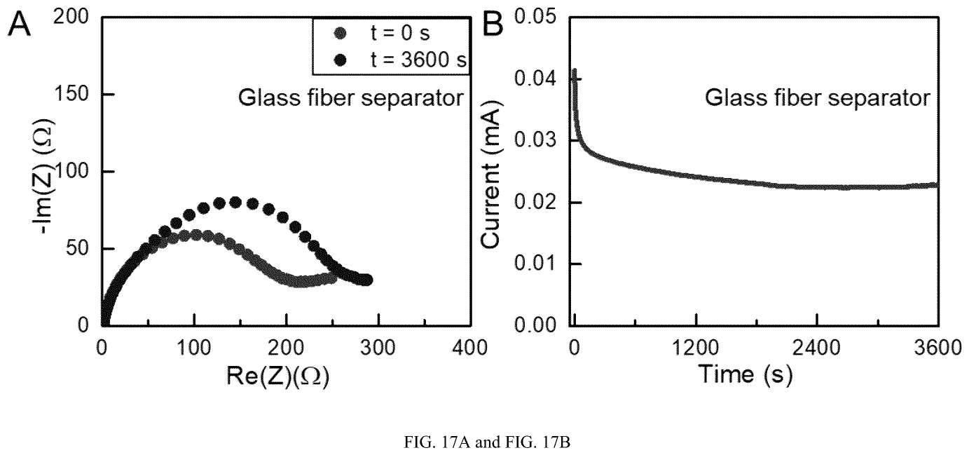

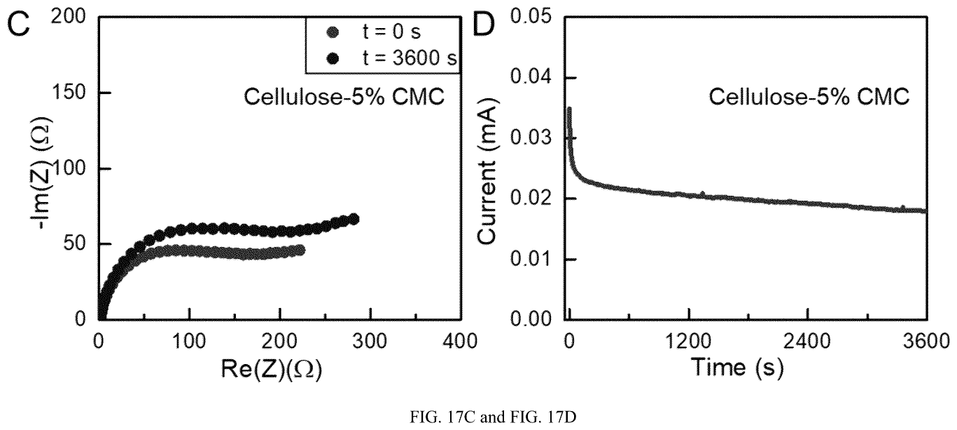

To better understand the Zn ion transport, the transference numbers of both a glass fiber separator with 2 M ZnSO₄ solution and the cellulose-5% CMC electrolyte after squeezing it dry were measured (FIGS. 17A-D and Table 3). The transference number of the cellulose-5% CMC (0.39) was only slightly higher than that of the glass fiber separator using aqueous electrolyte (0.33), implying that the dissociation of Zn²⁺ in the cellulose-CMC electrolyte occurs in a similar way as in aqueous solution. Based on this result, it is hypothesized that Zn²⁺ ions experience a similar environment in the cellulose-CMC sample as in bulk water, suggesting the Zn ions are fully solvated in the membrane. It is also be hypothesized that ion conduction may take place along channels formed by water molecules coordinated to the CMC molecules. However, additional studies are to confirm this structure are warranted.

TABLE 3
Parameters measured by DC polarization and EIS for the Zn²⁺
transference number.

| | I₀ (mA) | I_{SS} (mA) | R₀ (Ω) | R_{SS} (Ω) | t |
|---|---|---|---|---|---|
| Glass fiber | 0.041 | 0.023 | 173 | 231 | 0.33 |
| Cellulose-5% CMC | 0.035 | 0.018 | 138 | 174 | 0.39 |

I₀: initial current; I_{SS}: steady-state current; R₀: initial resistance; R_{SS}: steady-state resistance; t: transference number

### Example 2. Electrodeposition and Stripping of Zn

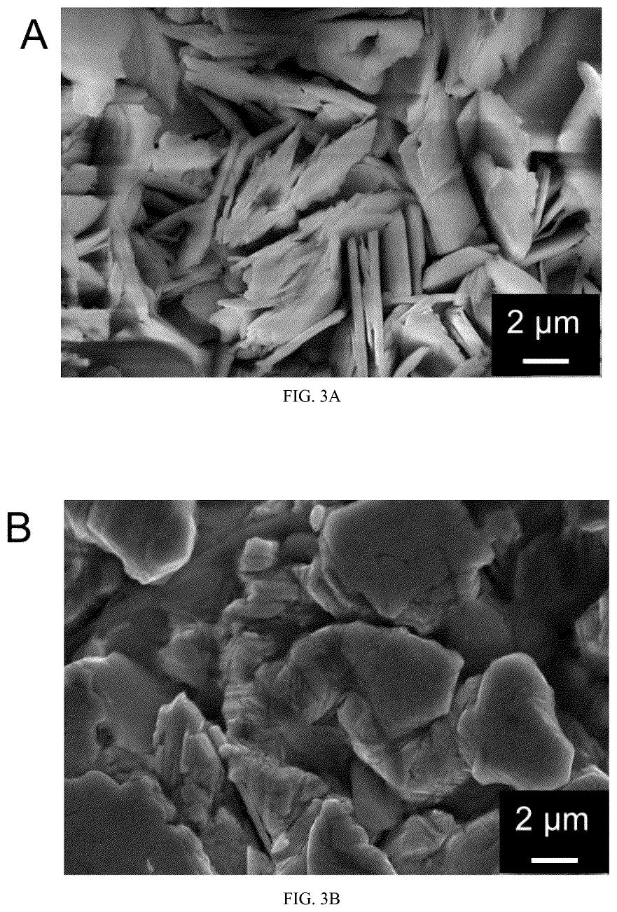

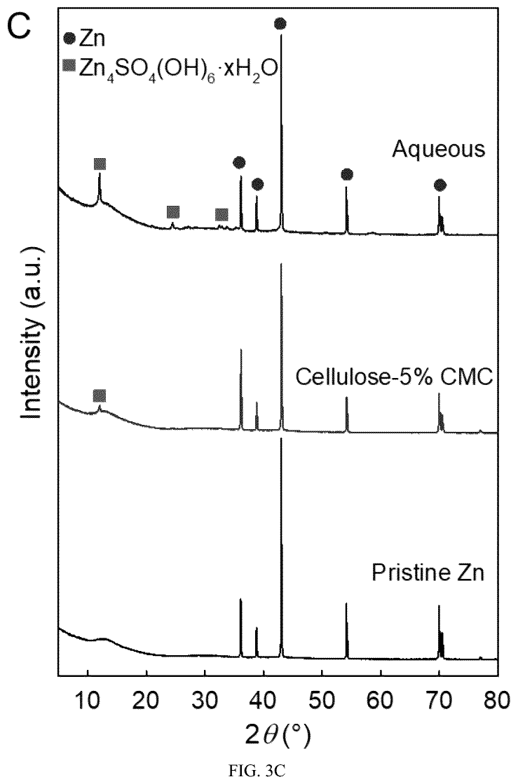

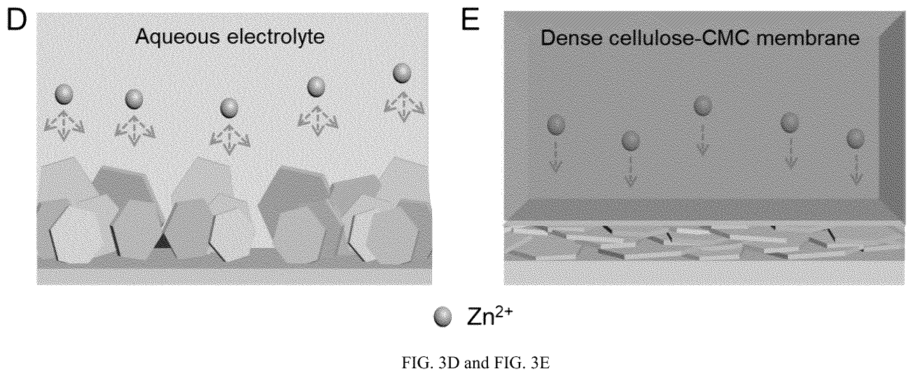

Using Zn∥Zn symmetric cells fabricated with cellulose-5% CMC electrolyte, the electrodeposition and stripping performance of Zn was tested and compared to a cell fabricated using a glass fiber separator and aqueous electrolyte (2M ZnSO₄ in deionized water). Both samples were cycled at a current density of 10 mA/cm² and a capacity density of 5 mAh/cm² for 50 cycles. After cycling, the Zn foils were removed from the cell for post-mortem SEM analysis. When Zn was plated using the aqueous electrolyte and glass fiber separator, Zn platelets were found to grow perpendicular to the surface of the Zn foil (FIG. 3A). In contrast, using the cellulose-5% CMC electrolyte, the formation of hexagonal Zn platelets were instead observed, oriented parallel to the Zn electrode surface (FIG. 3B). These results suggest the ability of the cellulose-5% CMC electrolyte to reduce Zn dendrite formation. XRD measurements were also performed on both samples, as well as pristine Zn foil for comparison. As shown in FIG. 3C, after cycling using the cellulose-5% CMC electrolyte, an increase in the relative intensity of the XRD peak was observed corresponding to the (002) planes (2θ=36°) of Zn (Table 4), which previous studies have shown is preferred for Zn growth parallel to the electrode surface. These results further demonstrate the preferred parallel growth of Zn platelets during electrodeposition.

TABLE 4
Relative XRD intensities I₀₀₂/I₁₀₁.

| Pristine Zn | Aqueous electrolyte | Cellulose-5% CMC |
|---|---|---|
| 27.26% | 27.62% | 47.50% |

The electrodeposition an stripping of Zn in the battery are likely impacted by multiple effects. For example, when using the aqueous electrolyte and glass separator, the Zn growth does not face much mechanical resistance, thus enabling the perpendicular orientation of the Zn platelets (FIG. 3D), which could promote dendritic growth. In contrast, the high mechanical strength and dense structure of the cellulose-5% CMC membrane inhibits the perpendicular growth of Zn, mechanically constraining the deposition within the narrow gap between the membrane surface and Zn foil such that parallel growth is preferred (FIG. 3E). Additionally, Zn²⁺ can migrate freely within the aqueous electrolyte (FIG. 3D). As a result, Zn ions will accumulate at regions of the electrode where the surface is rougher, creating “hot-spots” of deposition due to the higher concentrated electric field. This positive feedback will accelerate the perpendicular growth of Zn, which is the cause of dendrite formation in many other electrodeposition systems, such as Li-metal batteries. In contrast, the CMC chains within the cellulose-5% CMC electrolyte may help bond water molecules within the electrolyte, which could promote the migration of Zn ions along the CMC chains. Consequently, the Zn ions may distribute more evenly on the surface of the Zn foil rather than accumulate around potential “hot-spots.” Finally, as illustrated by the XRD pattern (FIG. 3C), Zn₄SO₄(OH)₆·xH₂O forms after cycling in aqueous electrolyte (peaks labeled by green squares). Due to the large free water content in the aqueous electrolyte, a Zn₄SO₄(OH)₆·xH₂O passivation layer forms on the surface of the Zn foil. The Zn₄SO₄(OH)₆·xH₂O byproduct is electrochemically inert and will prevent further Zn deposition. However, thanks to the strong bonding between CMC and water molecules within the cellulose-5% CMC electrolyte, there is reduced formation of Zn₄SO₄(OH)₆·xH₂O (FIG. 3C), allowing Zn to deposit over the entire Zn foil surface throughout cycling. All combined, these advantages of the cellulose-5% CMC electrolyte help suppress the dendritic, perpendicular growth of Zn, enabling stable and reversible Zn plating/stripping.

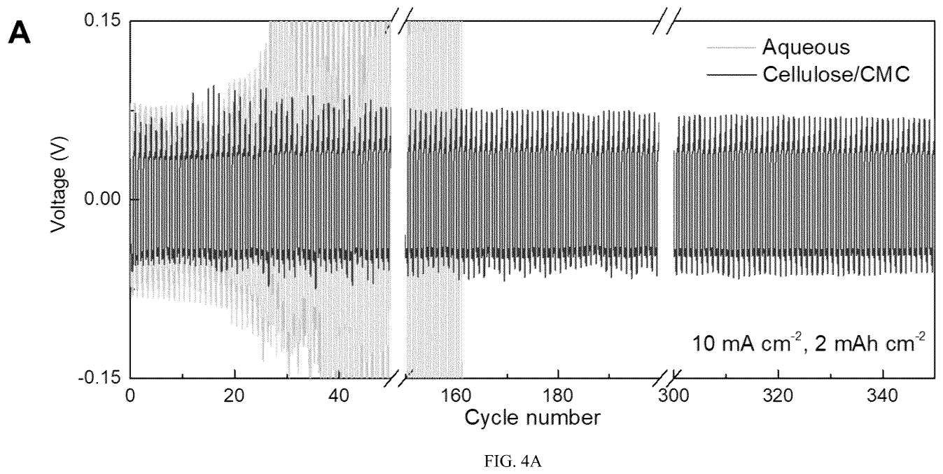

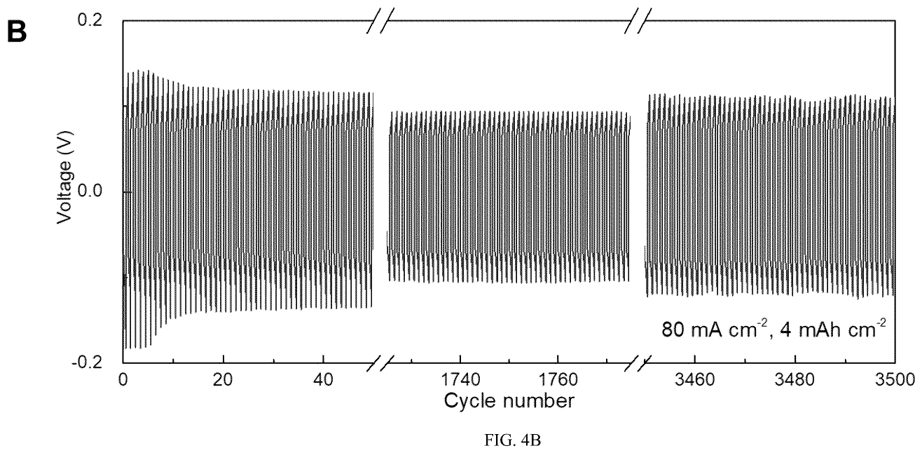

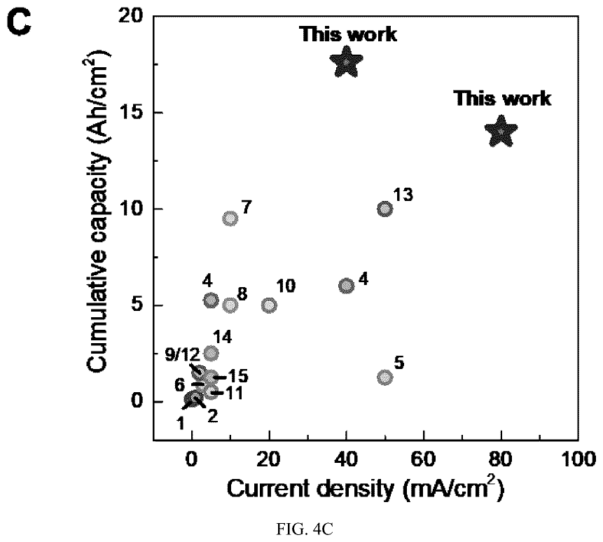

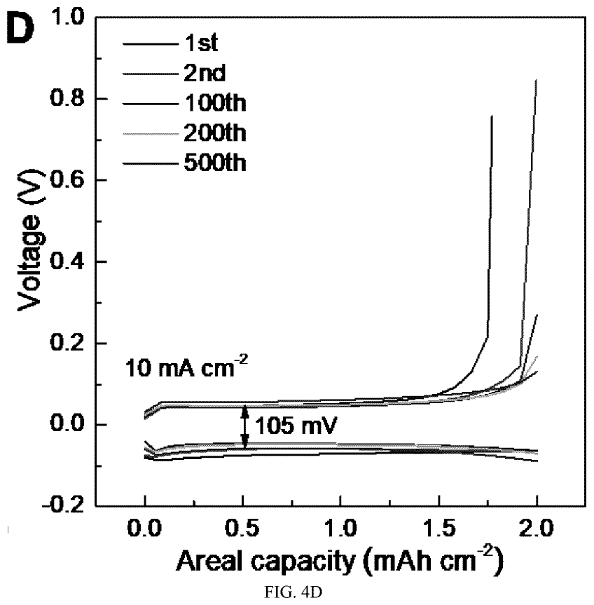

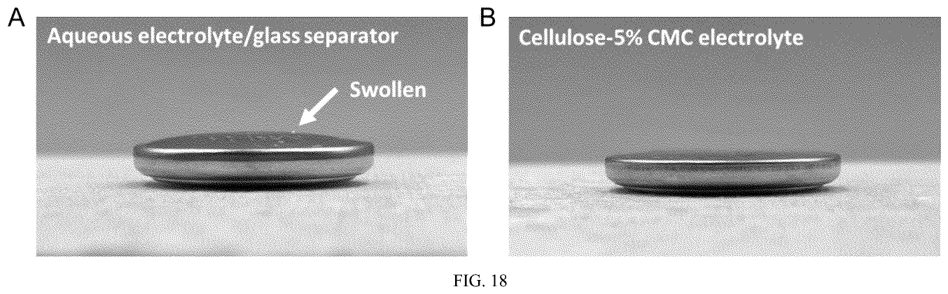

As shown in FIG. 4, excellent Zn∥Zn cycling performance is achieved using the cellulose-5% CMC electrolyte. With a current density of 10 mA/cm² and capacity of 5 mAh/cm², a symmetric cell with cellulose-5 wt % CMC electrolyte showed a polarization voltage of 50 mV (FIG. 4A, red), remaining approximately constant throughout 350 cycles. In contrast, using aqueous electrolyte with the glass fiber separator, the initial polarization is as large as 100 mV and quickly approaches an irreversible and dramatic increase after 30 cycles (FIG. 4A, grey). This comparison indicates that the Zn anode interface using the cellulose-5% CMC electrolyte has much greater durability. In addition to the stark difference in the polarization voltage behavior, the cell made with the aqueous electrolyte visibly swells after 160 cycles at 10 mA/cm² and 5 mAh/cm² (FIG. 18A). The inflation of the coin cell is likely caused by the hydrogen evolution reaction with free water molecules, which occurs on the Zn anode. Conversely, the cell with the cellulose-5% CMC electrolyte has no observable volumetric swelling after 350 cycles (FIG. 18B). The cellulose-CMC electrolyte bonds to water molecules strongly, and thus it appears to mitigate the long-standing issue of hydrogen evolution in aqueous Zn batteries.

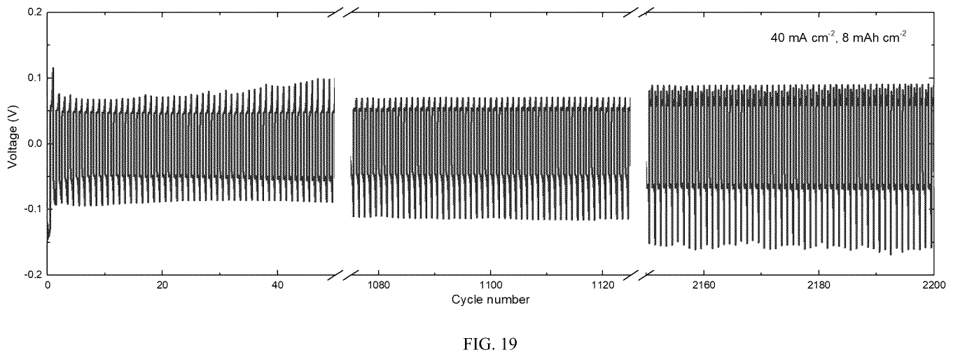

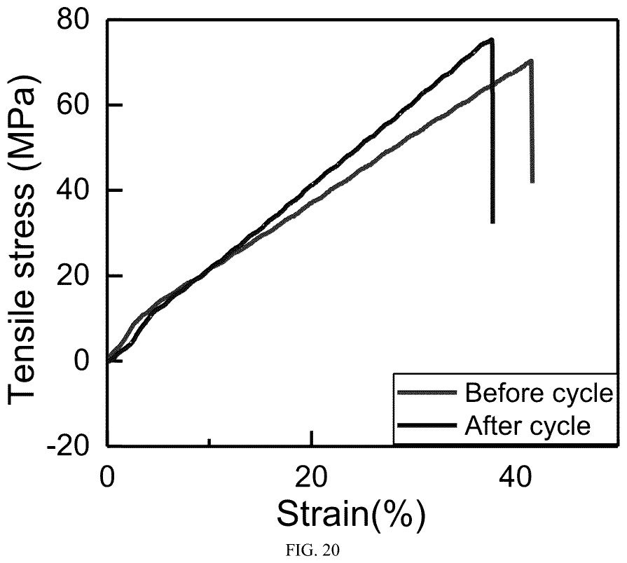

With the cellulose-5% CMC electrolyte, Zn symmetric cells were successfully cycled at 80 mA/cm² (4 mAh/cm², 3500 cycles, FIG. 4B) and 40 mA/cm² (8 mAh/cm², 2200 cycles, FIG. 19), with a cumulative plating capacity of 14 Ah/cm² and 17.6 Ah/cm², respectively. These results outperform previously reported Zn symmetric cells in terms of current density as well as cumulative plating capacity, including cells using hydrogel electrolytes and Zn salt with different additives (FIG. 4C), demonstrating the excellent potential of the cellulose-5% CMC electrolyte for ultra-fast charging-discharging of Zn-metal anodes. Additionally, the tensile strength did not change greatly after cycling (FIG. 20), demonstrating the mechanical durability of the electrolyte. However, during cycling, the polarization first decreased and then increased (FIG. 4B). To understand this behavior, EIS measurements were taken at the beginning and after 1700 and 3400 cycles, where it was found that the interfacial resistance first decreased, then increased. This evolution of the interfacial resistance could possibly be ascribed to the fact that during the initial cycles some interfacial activation occurred, which later improves the interfacial contact between the electrolyte and Zn foil. Then during further cycles, although largely reduced, some surface passivation species (e.g., Zn₄SO₄(OH)₆·xH₂O) still form on the surface of the Zn foil, as can be seen in the XRD results shown in FIG. 3C. This passivation layer may have resulted in the increasing polarization in the later stage of cycling. In addition, by comparing the x-intercept of the EIS spectra, it was found that the bulk resistivity increased about 25% after cycling, indicating that the bulk ionic conductivity decreases 20%. This could be due to the consumption of bound water during cycling.

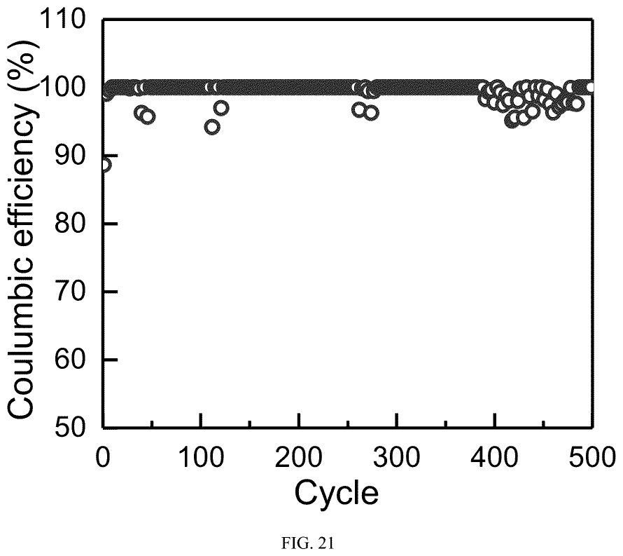

Using the cellulose-5% CMC electrolyte, the electrodeposition of Zn on Cu foil was also tested using a Zn∥Cu asymmetric cell at 10 mA/cm² with a capacity of 2 mAh/cm² and a cutoff voltage of 0.8 V (FIG. 4D). The cell showed a high average Coulombic efficiency of 99.5% over 500 cycles (FIG. 21) with a smaller voltage hysteresis of 105 mV. Both the Zn∥Zn and Zn∥Cu cells demonstrate the high stability, cyclability, and capability of the cellulose-5% CMC electrolyte to withstand a high current density, all of which is crucial for high power density aqueous ZIBs.

### Example 3. Zn∥MnO₂ Full Cell Performance

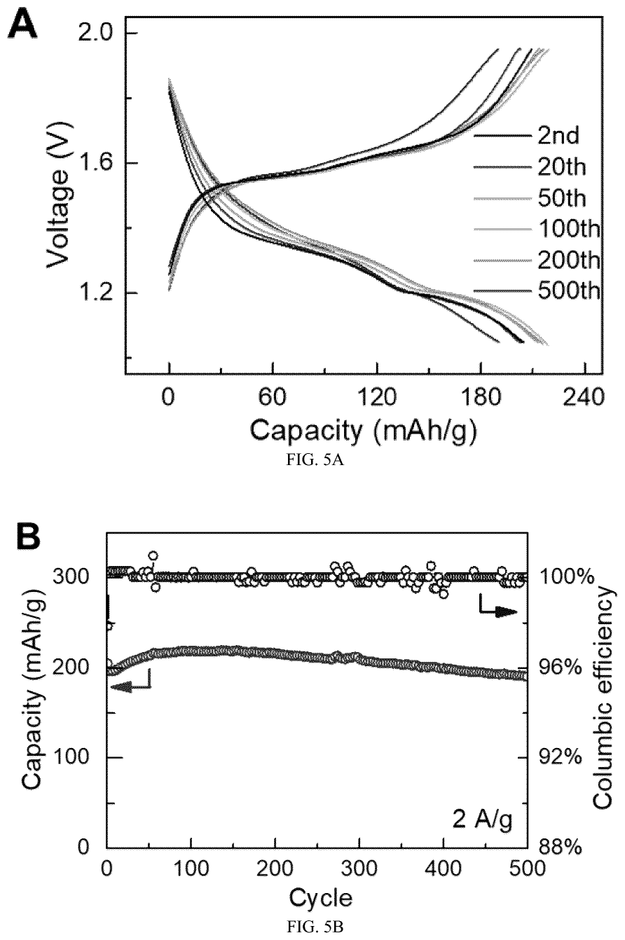

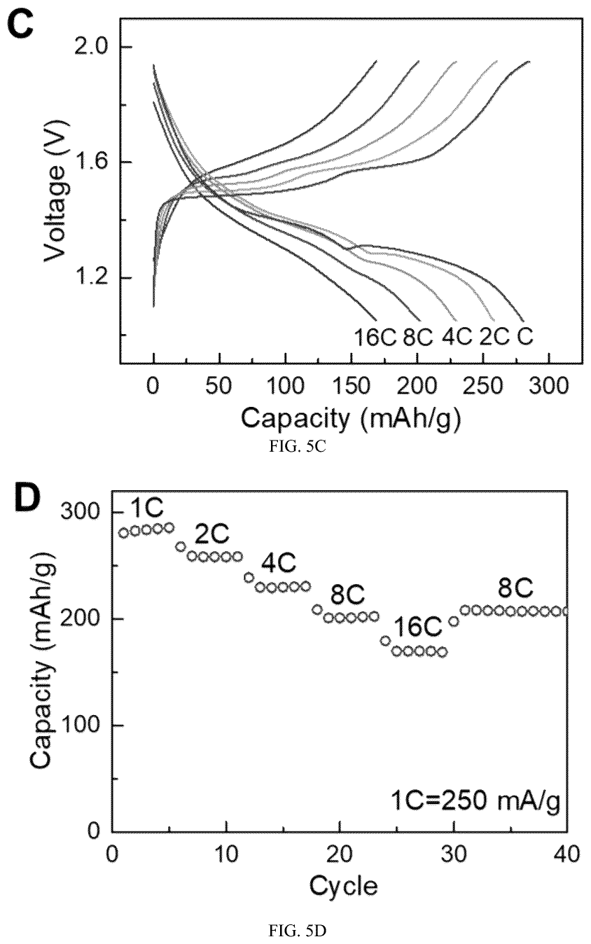

The conventional Zn∥MnO₂ chemistry was used to evaluate the performance of the cellulose-5% CMC electrolyte in full cells. MnO₂ nanorods were synthesized using a hydrothermal method and cast onto carbon paper as the cathode. The mass loading of MnO₂ was ˜6 mg/cm². As shown in FIG. 5A, the Zn∥MnO₂ full cell exhibits a high discharge/charge capacity of ˜200 mAh/g at an ultra-high rate of 8C (1C=250 mA/g). Additionally, a high capacity retention of 95% was achieved after 500 cycles (FIG. 5B). The battery experienced no short-circuit during this high-rate cycling, suggesting the inhibition of dendritic growth by the cellulose-5% CMC electrolyte.

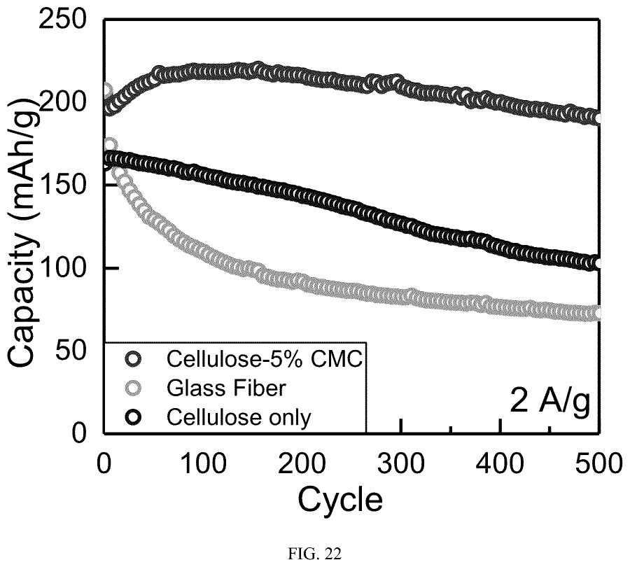

The Zn∥MnO₂ battery also demonstrates outstanding rate performance both in terms of discharge profile (FIG. 5C) and cycling performance (FIG. 5D), delivering discharge capacities of 284, 258, 230, and 201 mAh/g at 1C, 2C, 4C, and 8C, respectively. Even at a high rate of 16C, a discharge capacity of 170 mAh/g was achieved. The cycling performance of the cellulose-5% CMC electrolyte was compared to the cellulose-only electrolyte (0% CMC), as well as the aqueous electrolyte/glass fiber separator, where the cellulose-5% CMC electrolyte demonstrated the best performance (FIG. 22). Moreover, the capacity retention of the cellulose-5% CMC cell is high compared to other previously reported bio-based electrolytes for ZIBs (Table 5). These results clearly demonstrate the strong performance and compatibility of the cellulose-CMC electrolyte with the most commonly studied and low-cost Zn∥MnO₂ chemistry.

TABLE 5
A short summary of the cycling performance of previously reported
bio-based electrolytes for ZIBs.

| | | | Capacity | Current | | |
|---|---|---|---|---|---|---|
| Bio-material | Cathode | Cycle time | retention | density | | |
| This Work | MnO₂ | 500 cycles | 95% | 2 A/g | | Ref. |
| Densified | poly(benzoquinonyl | 400 cycles | 71% | 4 | mA/cm² | 1 |
| chitosan-Zn | sulfide) (PBQS) | | | | | |
| membrane | | | | | | |
| Nanoporous | NH₄V₄O₁₀ | 850 cycles | 89% | 4 | A/g | 2 |
| cellulose | | | | | | |
| paper@glass fiber | | | | | | |
| separator | | | | | | |
| Cellulose | Mg_{0.23}V₂O₅•1.0H₂O | 180 cycles | 81.7% | 500 | mA/g | 3 |
| nanofiber-PAM | | | | | | |
| hydrogel | | | | | | |
| Hydrogel | MnO₂ | 500 cycles | / | 200 | mA/g | 4 |
| reinforced | | | | | | |
| cellulose paper | | | | | | |
| Cellulose | MnO₂/graphite | 3000 cycles | 87.2% | 2.5 | A/g | 5 |
| nanofibers-ZrO₂ | | | | | | |
| composite | | | | | | |
| separator | | | | | | |
| Cellulose aerogel- | MnO₂ nanorod/rGO | 100 cycles | ~75% | 61.6 | mA/g | 6 |
| gelatin solid | | | | | | |
| electrolyte | | | | | | |
| Cellulose | I₂@C | 1000 cycles | 80% | 200 | mA/g | 7 |
| nanofiber zinc | | | | | | |
| sulfonate | | | | | | |
| membrane | | | | | | |
| Cotton-derived | α-MnO₂ | 1000 cycles | 63.6% | 1 | A/g | 8 |
| cellulose film | | | | | | |
| Bamboo cellulose | MnO₂ | 1000 cycles | / | 1 | A/g | 9 |
| membrane | | | | | | |
| Commercial | V₂O₅ | 1000 cycles | / | 0.5 | A/g | 10 |
| weighing paper | | | | | | |
| interlayer | | | | | | |

### Example 4. Materials and Methods

3 wt % cellulose nanofiber gel was purchased from SAPPI. Carboxymethyl cellulose (CMC) powder (400,000 g/mol), polyvinylidene fluoride (PVDF) powder (>99.5%), and zinc foil (100 μm in thickness, 99.9%) were purchased from MTI corporation. Sodium hydroxide (NaOH, 97%), Zinc sulfate heptahydrate (99%), N-methyl-2-pyrrolidone (NMP, 99.5%), ammonium persulfate (98%), and manganese (II) sulfate monohydrate (>98%) were purchased from Millipore Sigma. All materials were used directly without any treatment.

### Example 5. Preparation of the Cellulose-CMC Membrane

CMC was first dissolved in DI water by stirring overnight at room temperature to produce a 0.5 wt % CMC solution. Then 1.33 g of 3 wt % cellulose nanofiber gel was added to 40 mL DI water. After that, 0, 16, 42, or 69 mg of 0.5 wt % CMC solution was slowly pipetted into the dispersion to produce samples with 0%, 2%, 5% and 8% CMC contents. The dispersion was mixed using a vortex mixer for 10 minutes, then bath sonicated for 30 minutes, which yielded a uniform dispersion with no visible aggregation. The dispersion was then vacuum filtrated through a PVDF filter membrane (Durapore, 0.65 μm pore size), which yielded a wet cellulose-CMC film that could be easily peeled off from the filter. The film was immediately immersed in 20 wt % NaOH solution for 12 hours, then rinsed with DI water until the rinsing solution reached pH 7. The membrane was stored in DI water for further treatment.

### Example 6. Preparation of the cellulose-CMC electrolyte

The cellulose-CMC membrane was immersed in 2 M ZnSO₄ aqueous solution overnight for Zn plating/stripping tests, or immersed in 2 M ZnSO₄/0.1M MnSO₄ aqueous solution overnight for Zn∥MnO₂ full cell tests. The cellulose-CMC electrolyte was obtained after squeezing between Kimwipes with a pressure of 0.5 MPa (squeeze-dry).

### Example 7. Water Uptake and Water Retention Measurements

To measure the water uptake, the membranes were first dried in a vacuum oven at 100° C. for 12 hours to remove all water, and then soaked in deionized water for one hour. The water uptake was defined by the ratio between the mass of the dry membrane and the mass of the soaked membranes. For water retention tests, the soaked membranes were placed in an ambient environment of 25° C. and 1% relative humidity. Then the masses of the membranes were measured every 20 minutes and recorded.

### Example 8. EIS Tests

EIS tests were performed with stainless steel plates as blocking electrodes. The cellulose-CMC electrolyte was sandwiched between two stainless steel plates and then assembled within a CR2032 coin cell for EIS measurements. The cellulose-CMC electrolyte had a thickness of 80 μm. The EIS data was measured using a Biologic VMP3 electrochemical workstation at an amplitude of 10 mV at an open circuit voltage.

### Example 9. Transference Number Measurement

The Zn²⁺ transference numbers were measured using the Bruce-Vincent method. DC polarization measurements were conducted with a potential of ΔV=10 mV in the Zn∥Zn cells until the current reached a steady state, and corresponding EIS measurements were collected before and after the DC polarization. The Zn²⁺ transference number (t_{Zn}) was calculated according to:

$${t}_{Zn} = \frac{{I}_{SS} ( ΔV - {I}_{0} {R}_{0} )}{{I}_{0} ( ΔV - {I}_{SS} {R}_{SS} )}$$

where ΔV is the applied potential, I₀ is the initial current, R₀ is the initial resistance, Iₛₛ is the steady-state current, and Rₛₛ is the steady-state resistance.

### Example 10. Electrochemical Tests for Zn Plating/Stripping

Zn symmetric cells were assembled using Zn foils for both the cathode and anode, and either the cellulose-CMC electrolyte or aqueous electrolyte (100 μL 2 M ZnSO₄) with a glass fiber separator. The asymmetric Cu∥Zn cells were assembled using Cu foil and Zn foil as the cathode and anode. All cells were assembled in ambient environment using CR2032 coin cells and tested at room temperature. The galvanostatic plating/stripping profiles were measured by a NEWARE battery testing system.

### Example 11. Electrochemical Tests for Zn∥MnO₂ Full Cell

MnO₂ nanorods were synthesized by a hydrothermal method reported in the literature. To prepare composite electrodes, MnO₂, Ketjenblack EC-600JD, and PVDF were mixed at a mass ratio of 8:1:1 within NMP. The resulting slurry was then cast onto carbon paper and dried at 100° C. under vacuum for 12 hours before cell assembly. The areal loading of the active material was ˜6 mg/cm². The electrochemical performances of the composite electrodes were evaluated in a CR2032 coin cell with a zinc foil anode and cellulose-CMC electrolyte (ZnSO₄/MnSO₄). The galvanostatic charging/discharging profiles were measured by a NEWARE battery testing system. All electrochemical tests were run at room temperature.

### REFERENCES

A number of patents and publications are cited above in order to more fully describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.
ADDIN Mendeley Bibliography CSL_BIBLIOGRAPHY [1] F. Creutzig, P. Jochem, O. Y. Edelenbosch, L. Mattauch, D. P. van Vuuren, D. McCollum, J. Minx, Science (80-.). 2015, 350, 911.
[2] J.-M. Tarascon, Nat. Mater. 2022, DOI 10.1038/s41563-022-01342-x.
[3] X. Yu, A. Manthiram, Adv. Energy Sustain. Res. 2021, 2, 2000102.
[4] C. Xia, J. Guo, Y. Lei, H. Liang, C. Zhao, H. N. Alshareef, Adv. Mater. 2018, 30, 1705580.
[5] Y. Zhang, Z. Chen, H. Qiu, W. Yang, Z. Zhao, J. Zhao, G. Cui, NPG Asia Mater. 2020, 12, 4.
[6] D. Chao, W. Zhou, F. Xie, C. Ye, H. Li, M. Jaroniec, S.-Z. Qiao, Sci. Adv. 2020, 6, DOI 10.1126/sciadv.aba4098.
[7] P. Xu, D. H. S. Tan, Z. Chen, Trends Chem. 2021, 3, 620.
[8] T. Zhang, Y. Tang, S. Guo, X. Cao, A. Pan, G. Fang, J. Zhou, S. Liang, Energy Environ. Sci. 2020, 13, 4625.
[9] L. E. Blanc, D. Kundu, L. F. Nazar, Joule 2020, 4, 771.
[10] B. Yong, D. Ma, Y. Wang, H. Mi, C. He, P. Zhang, Adv. Energy Mater. 2020, 10, 2002354.
[11] V. Verma, S. Kumar, W. Manalastas, M. Srinivasan, ACS Energy Lett. 2021, 6, 1773.
[12] L. Kang, M. Cui, F. Jiang, Y. Gao, H. Luo, J. Liu, W. Liang, C. Zhi, Adv. Energy Mater. 2018, 8, 1801090.
[13] D. J. Arnot, M. B. Lim, N. S. Bell, N. B. Schorr, R. C. Hill, A. Meyer, Y. T. Cheng, T. N. Lambert, Adv. Energy Mater. 2021, 11, DOI 10.1002/aenm.202101594.
[14] C. Ma, K. Yang, S. Zhao, Y. Xie, C. Liu, N. Chen, C. Wang, D. Wang, D. Zhang, Z. X. Shen, F. Du, ACS Energy Lett. 2023, 8, 1201.
[15] C. Chen, K. Matsumoto, K. Kubota, R. Hagiwara, Q. Xu, Adv. Energy Mater. 2019, 9, 1900196.
[16] F. Wang, O. Borodin, T. Gao, X. Fan, W. Sun, F. Han, A. Faraone, J. A. Dura, K. Xu, C. Wang, Nat. Mater. 2018, 17, 543.
[17] H. Yang, Z. Chang, Y. Qiao, H. Deng, X. Mu, P. He, H. Zhou, Angew. Chemie Int. Ed. 2020, 59, 9377.
[18] A. Naveed, H. Yang, J. Yang, Y. Nuli, J. Wang, Angew. Chemie Int. Ed. 2019, 58, 2760.
[19] N. Wang, Y. Yang, X. Qiu, X. Dong, Y. Wang, Y. Xia, ChemSusChem 2020, 13, 5556.
[20] Y. Ding, Z. Pang, K. Lan, Y. Yao, G. Panzarasa, L. Xu, M. Lo Ricco, D. R. Rammer, J. Y. Zhu, M. Hu, X. Pan, T. Li, I. Burgert, L. Hu, Chem. Rev. 2022, DOI 10.1021/acs.chemrev.2c00450.
[21] Q. Dong, X. Zhang, J. Qian, S. He, Y. Mao, A. H. Brozena, Y. Zhang, T. P. Pollard, O. A. Borodin, Y. Wang, B. S. Chava, S. Das, P. Zavalij, C. U. Segre, D. Zhu, L. Xu, Y. Liang, Y. Yao, R. M. Briber, T. Li, L. Hu, Sci. Adv. 2022, 8, DOI 10.1126/sciadv.add2031.
[22] Z. Yang, W. Li, Q. Zhang, C. Xie, H. Ji, Y. Tang, Y. Li, H. Wang, Mater. Today Energy 2022, 28, 101076.
[23] J. Zhou, R. Zhang, R. Xu, Y. Li, W. Tian, M. Gao, M. Wang, D. Li, X. Liang, L. Xie, K. Liang, P. Chen, B. Kong, Adv. Funct. Mater. 2022, 32, 1.
[24] L. Ma, S. Chen, D. Wang, Q. Yang, F. Mo, G. Liang, N. Li, H. Zhang, J. A. Zapien, C. Zhi, Adv. Energy Mater. 2019, 9, 1.
[25] W. Xu, C. Liu, Q. Wu, W. Xie, W. Y. Kim, S. Y. Lee, J. Gwon, J. Mater. Chem. A 2020, 8, 18327.
[26] J. Fu, H. Wang, P. Xiao, C. Zeng, Q. Sun, H. Li, Energy Storage Mater. 2022, 48, 191.
[27] H. Glatz, E. Lizundia, F. Pacifico, D. Kundu, ACS Appl. Energy Mater. 2019, 2, 1288.
[28] M. Xu, H. Dou, Z. Zhang, Y. Zheng, B. Ren, Q. Ma, G. Wen, D. Luo, A. Yu, L. Zhang, X. Wang, Z. Chen, Angew. Chemie—Int. Ed. 2022, 61, DOI 10.1002/anie.202117703.
[29] Y. Zhang, Y. Chen, X. Li, M. Alfred, D. Li, F. Huang, Q. Wei, J. Power Sources 2021, 482, 228963.
[30] N. Zhao, F. Wu, Y. Xing, W. Qu, N. Chen, Y. Shang, M. Yan, Y. Li, L. Li, R. Chen, ACS Appl. Mater. Interfaces 2019, 11, 15537.
[31] J. Cao, D. Zhang, C. Gu, X. Zhang, M. Okhawilai, S. Wang, J. Han, J. Qin, Y. Huang, Nano Energy 2021, 89, 106322.
[32] W. Zhou, M. Chen, Q. Tian, J. Chen, X. Xu, C. P. Wong, Energy Storage Mater. 2022, 44, 57.
[33] Y. Guo, W. Cai, Y. Lin, Y. Zhang, S. Luo, K. Huang, H. Wu, Y. Zhang, Energy Storage Mater. 2022, 50, 580.
[34] P. Yang, J. Li, S. W. Lee, H. J. Fan, Adv. Sci. 2022, 9, 1.
[35] X. Ge, W. Zhang, F. Song, B. Xie, J. Li, J. Wang, X. Wang, J. Zhao, G. Cui, Adv. Funct. Mater. 2022, 32, 1.
[36] J. Cao, D. Zhang, C. Gu, X. Wang, S. Wang, X. Zhang, J. Qin, Z. Wu, Adv. Energy Mater. 2021, 11, 2101299.
[37] X. Zhang, J. Li, D. Liu, M. Liu, T. Zhou, K. Qi, L. Shi, Y. Zhu, Y. Qian, Energy Environ. Sci. 2021, 14, 3120.
[38] D. Wang, H. Li, Z. Liu, Z. Tang, G. Liang, F. Mo, Q. Yang, L. Ma, C. Zhi, Small 2018, 14, 1803978.
[39] L. Yang, L. Song, Y. Feng, M. Cao, P. Zhang, X. F. Zhang, J. Yao, J. Mater. Chem. A 2020, 8, 12314.
[40] K. Boruvkova, J. Wiener, AUTEX Res. J. 2011, 11, 110.
[41] W. J. Zheng, J. Gao, Z. Wei, J. Zhou, Y. M. Chen, Eur. Polym. J. 2015, 72, 514.
[42] K. Abe, H. Yano, Cellulose 2012, 19, 1907.
[43] Y. S. Zhu, S. Y. Xiao, M. X. Li, Z. Chang, F. X. Wang, J. Gao, Y. P. Wu, J. Power Sources 2015, 288, 368.
[44] M. Chen, J. Chen, W. Zhou, J. Xu, C.-P. Wong, J. Mater. Chem. A 2019, 7, 26524.
[45] H. Li, Z. Liu, G. Liang, Y. Huang, Y. Huang, M. Zhu, Z. Pei, Q. Xue, Z. Tang, Y. Wang, B. Li, C. Zhi, ACS Nano 2018,12, 3140.
[46] J. Gong, J. Li, J. Xu, Z. Xiang, L. Mo, RSC Adv. 2017, 7, 33486.
[47] F. Fahma, F. A. Lestari, I. A. Kartika, N. Lisdayana, E. S. Iriani, Karbala Int. J. Mod. Sci. 2021, 7, DOI 10.33640/2405-609X.1892.
[48] A. Tarbuk, A. M. Grancaric, M. Leskovac, Cellulose 2014, 21, 2167.
[49] M. Ferro, A. Mannu, W. Panzeri, C. H. J. Theeuwen, A. Mele, Polymers (Basel). 2020, 12, 1559.
[50] M. Zhou, S. Guo, J. Li, X. Luo, Z. Liu, T. Zhang, X. Cao, M. Long, B. Lu, A. Pan, G. Fang, J. Zhou, S. Liang, Adv. Mater. 2021, 33, 1.
[51] Y. Liu, J. Hu, Q. Lu, M. Hantusch, H. Zhang, Z. Qu, H. Tang, H. Dong, O. G. Schmidt, R. Holze, M. Zhu, Energy Storage Mater. 2022, 47, 98.
[52] B. Zhang, L. Qin, Y. Fang, Y. Chai, X. Xie, B. Lu, S. Liang, J. Zhou, Sci. Bull. 2022, 67, 955.
[53] Q. Yang, L. Li, T. Hussain, D. Wang, L. Hui, Y. Guo, G. Liang, X. Li, Z. Chen, Z. Huang, Y. Li, Y. Xue, Z. Zuo, J. Qiu, Y. Li, C. Zhi, Angew. Chemie—Int. Ed. 2022, 61, DOI 10.1002/anie.202112304.
[54] L. Wang, W. Huang, W. Guo, Z. H. Guo, C. Chang, L. Gao, X. Pu, Adv. Funct. Mater. 2022, 32, 2108533.
[55] J. Zhao, J. Zhang, W. Yang, B. Chen, Z. Zhao, H. Qiu, S. Dong, X. Zhou, G. Cui, L. Chen, Nano Energy 2019, 57, 625.
[56] M. Zhu, X. Wang, H. Tang, J. Wang, Q. Hao, L. Liu, Y. Li, K. Zhang, O. G. Schmidt, Adv. Funct. Mater. 2020, 30, 1.
[57] P. Liang, J. Yi, X. Liu, K. Wu, Z. Wang, J. Cui, Y. Liu, Y. Wang, Y. Xia, J. Zhang, Adv. Funct. Mater. 2020, 30, 1.
[58] Y. Yin, S. Wang, Q. Zhang, Y. Song, N. Chang, Y. Pan, H. Zhang, X. Li, Adv. Mater. 2020, 32, 1.
[59] W. Guo, Y. Zhang, X. Tong, X. Wang, L. Zhang, X. Xia, J. Tu, Mater. Today Energy 2021, 20, DOI 10.1016/j.mtener.2021.100675.
[60] L. Qian, W. Yao, R. Yao, Y. Sui, H. Zhu, F. Wang, J. Zhao, C. Zhi, C. Yang, Adv. Funct. Mater. 2021, 31, 1.
[61] P. Cao, X. Zhou, A. Wei, Q. Meng, H. Ye, W. Liu, J. Tang, J. Yang, Adv. Funct. Mater. 2021, 31, 1.
[62] H. Yan, S. Li, Y. Nan, S. Yang, B. Li, Adv. Energy Mater. 2021, 11, 1.
[63] L. Ma, S. Chen, N. Li, Z. Liu, Z. Tang, J. A. Zapien, S. Chen, J. Fan, C. Zhi, Adv. Mater. 2020, 32, 1.
[64] S. S. Shinde, J. Y. Jung, N. K. Wagh, C. H. Lee, D. H. Kim, S. H. Kim, S. U. Lee, J. H. Lee, Nat. Energy 2021, 6, 592.
[65] G. Zhang, X. Zhang, H. Liu, J. Li, Y. Chen, H. Duan, Adv. Energy Mater. 2021, 11, 2003927.
[66] Y. Zhang, G. Wang, F. Yu, G. Xu, Z. Li, M. Zhu, Z. Yue, M. Wu, H.-K. Liu, S.-X. Dou, C. Wu, Chem. Eng. J. 2021, 416, 128062.
[67] M. Wu, Y. Zhang, L. Xu, C. Yang, M. Hong, M. Cui, B. C. Clifford, S. He, S. Jing, Y. Yao, L. Hu, Matter 2022, DOI 10.1016/j.matt.2022.07.015.
[68] W. Sun, F. Wang, S. Hou, C. Yang, X. Fan, Z. Ma, T. Gao, F. Han, R. Hu, M. Zhu, C. Wang, J. Am. Chem. Soc. 2017, 139, 9775.
[69] X. Wang, Y. Li, J. Am. Chem. Soc. 2002, 124, 2880.

We claim:

1. An electrolyte membrane composition, said composition comprising cellulose, carboxymethylcellulose, one or more salts, and water, wherein said water is bound water.

2. The composition of claim 1, wherein said composition comprises about 75% to about 99.9% cellulose by weight.

3. The composition of claim 1, wherein said material comprises about 0.1% to about 25% carboxymethylcellulose by weight.

4. The composition of claim 1, wherein said material comprises about 95% cellulose and about 5% carboxymethylcellulose by weight.

5. The composition of claim 1, wherein the bound water is present in the range of about 0.01% to about 80% by weight.

6. The composition of claim 1, wherein said one or more salts have the form of XY, wherein X is a positively charged cation, Y is a negatively charged anion, and are combined in such a way as to render a neutral overall charge; wherein X is chosen from Zn²⁺, Li⁺, Na⁺, K⁺, NH₄⁺, Al³⁺, and Mg²⁺; and, wherein Y is chosen from SO₄²⁻, Cl⁻, CF₃SO₃⁻, and NO₃⁻.

7. The composition of claim 6, wherein said salt is ZnSO₄.

8. An electrolyte membrane, said membrane comprising a electrolyte membrane composition of claim 1.

9. The membrane of claim 8, wherein said membrane is porous and has pores with a size in the range of about 1 nm to about 1 mm.

10. A method of making a electrolyte membrane, said method comprising the steps of:
suspending cellulose in water;
dissolving carboxymethylcellulose in water to form a solution;
combining the carboxymethylcellulose solution with the cellulose suspension;
thoroughly mixing the subsequent suspension;
and a separation step.

11. The method of claim 10, wherein the separation step may be chosen from evaporation, vacuum filtration, and gravity filtration.

12. The method of claim 10, further comprising the steps of soaking the membrane for a period of time in an NaOH solution; rinsing the material with water; and
applying pressure to remove excess water.

13. The method of claim 12, wherein said period of time is in the range of about 1 hour to about 24 hours.

14. The method of claim 12, wherein said NaOH solution has a concentration in the range of about 1% to about 40% by weight.

15. A battery, said battery comprising a cathode, an anode, and a electrolyte membrane of claim 8.

16. The battery of claim 15, wherein said cathode comprises Zn, Cu, V₂O₅, LiFePO₄, NH₄V₄O₁₀, MnO₂, or combinations thereof.

17. The battery of claim 15, wherein said anode comprises Zn, Al, Mg, Li, K, Na, Si, graphite, or combinations thereof.

18. The batter of claim 17, wherein the battery is a symmetric cell, an asymmetric cell, or a full cell.
